(19) United States
(12) Patent Application Publication
(10) Pub. No.: US 2013/0147783 A1
(43) Pub. Date: Jun. 13, 2013

(54) PIXEL CIRCUIT AND DISPLAY DEVICE

(71) Applicant: Yoshimitsu Yamauchi, Osaka-shi (JP)

(72) Inventor: Yoshimitsu Yamauchi, Osaka-shi (JP)

(73) Assignee: SHARP KABUSHIKI KAISHA, Osaka-shi, Osaka (JP)

(21) Appl. No.: 13/818,055

(22) PCT Filed: May 23, 2011
(86) PCT No.: PCT/JP2011/061716

§ 371 Date: Feb. 20, 2013

(30) Foreign Application Priority Data
Aug. 31, 2010 (JP) 2010-194668

(51) Int. Cl. G09G 3/36

(52) U.S. Cl. CPC G09G 3/3696
USPC 345/212

(57) ABSTRACT

A pixel circuit includes a display element unit including a unit liquid crystal display element having a liquid crystal layer between a pixel electrode and a counter electrode, a capacitor element having a tunnel insulating film between first and second electrodes wherein a tunnel current flows between the electrodes when a predetermined high voltage is applied between the electrodes, and a switch circuit having a first terminal connected to the second electrode of the capacitor element, a second terminal connected to a data signal line, and a control terminal connected to a scanning signal line, the control terminal controlling electrical connection between the first and second terminals. A voltage corresponding to pixel data with a voltage of the counter electrode being a reference is held in an internal node connecting the pixel electrode and the first electrode of the capacitor element.

### TECHNICAL FIELD

The present invention relates to a pixel circuit and a display device including the pixel circuit and, more particularly, relates to an active matrix liquid crystal display device.

### BACKGROUND ART

FIG. 16 illustrates an equivalent circuit of a pixel circuit of a common active matrix liquid crystal display device. Further, FIG. 17 illustrates an example of a circuit arrangement in an active matrix liquid display device of m×n pixels. As illustrated in FIG. 17, a switching element formed with a thin film transistor (TFT) is provided at each intersection of m source lines (data signal lines) and n scanning lines (scanning signal lines) and, as illustrated in FIG. 16, a liquid crystal element LC and a retentive capacity Cs are connected in parallel through the TFT. The liquid crystal element LC adopts a layered structure in which a liquid crystal layer is provided between a pixel electrode and a counter electrode (common electrode). In addition, FIG. 17 briefly illustrates only a TFT and a pixel electrode (black rectangular portion) of each pixel circuit. In the retentive capacity Cs, one end is connected to the pixel electrode and the other end is connected to a capacity line LCs to stabilize a pixel data voltage held in the pixel electrode. The retentive capacity Cs provides an effect of suppressing fluctuation of the pixel data voltage held in the pixel electrode due to a leak current of a TFT, fluctuation of an electrical capacitance of the liquid crystal element LC between black display and white display due to dielectric anisotropy of liquid crystal particles, and voltage fluctuation caused by parasitic capacitance between the pixel electrode and a surrounding wiring. By sequentially controlling voltages of scanning lines, the TFTs connected to one scanning line enter a conducted state, and the pixel data voltages supplied to respective source lines are written in corresponding pixel electrodes with respect to each scanning line.

Even when display content is a still image upon normal display of full color display, by repeatedly writing the same display content in the same pixel with respect to each frame while inverting the voltage polarity applied to the liquid crystal element LC, the pixel data voltage held in the pixel electrode is updated, voltage fluctuation of pixel data is minimized, and high quality still image display is secured. An action for writing the pixel data while inverting the polarity of a voltage applied to the liquid crystal element LC every application of the voltage is referred to as a “counter AC driving” hereinafter.

Power consumption for driving a liquid crystal display device is mostly occupied by power consumption for driving source lines by a source driver, and can be roughly expressed by a relational expression shown in following equation 1. In equation 1, P represents power consumption, f represents a refresh rate (the number of times of refresh operations in one frame per unit time), C represents a load capacitance driven by a source driver, V represents a driving voltage of the source driver, n represents the number of scanning lines and m represents the number of source lines. In addition, the refresh operation is directed to canceling fluctuation produced in a voltage (absolute value) corresponding to pixel data applied to the liquid crystal element LC by writing the pixel data again, and returning the voltage to the original voltage state corresponding to the pixel data.

P∝f·C·V₂·n·m (Equation 1)

Meanwhile, when a still image is constantly displayed, display content is a still image, and therefore the pixel data voltage does not necessarily need to be updated for each frame. Hence, to further reduce the power consumption of the liquid crystal display device, a refresh frequency upon this constant display is decreased. However, when the refresh frequency is decreased, the pixel voltage held in the pixel electrode fluctuates due to the leak current of the TFT. Further, the average potential in each frame period decreases, and therefore this voltage fluctuation causes fluctuation of display brightness (the transmittance of liquid crystal) of each pixel, and is observed as a flicker. Furthermore, there is also a concern that, for example, sufficient contract cannot be obtained, and therefore display quality decreases.

Meanwhile, for example, Patent Documents 1 and 2 disclose configurations as a method of solving a problem that display quality decreases due to a decrease in the refresh frequency upon constant display of a still image. According to the configurations disclosed in Patent Documents 1 and 2, a switching element of a pixel circuit illustrated in FIG. 16 is formed with a series circuit of two TFTs (transistors T1 and T2), an intermediate node N2 between the two TFTs is driven to have the same potential as a pixel electrode N1 using a buffer amplifier 50 of a unity gain, and a problem that display quality decreases is solved by substantially suppressing the leak current of the TFT by preventing the voltage from being applied between a source and a drain of the TFT (T2) arranged on a pixel electrode side (see FIGS. 18 and 19).

This is a solution method which takes into account a substantial increase in the leak current of the TFT following an increase in a bias voltage between the source and the drain. As illustrated in FIGS. 18 and 19, according to the configurations disclosed in Patent Documents 1 and 2, although the bias voltage between the source and the drain increases in the TFT (T1) connected to the source line SL and the leak current of the TFT is likely to increase, the leak current is compensated for by the buffer amplifier 50 and does not influence the pixel voltage held in the pixel electrode N1. According to this configuration with the buffer amplifier 50, a problem that display quality decreases due to a decrease in the refresh frequency is solved, and power consumption is further reduced due to a decrease in the refresh frequency. Further, the configurations disclosed in Patent Documents 1 and 2 can support two or more different voltage states as the pixel voltage held in the pixel electrode, and can realize high quality constant display having multiple tones with low power consumption.

### PRIOR ART DOCUMENT

### Patent Document

Patent Document 1: Japanese Patent Application Laid-Open Publication No. 5-142573

Patent Document 2: Japanese Patent Application Laid-Open Publication No. 10-62817

### SUMMARY OF THE INVENTION

### Problems to be Solved by the Invention

However, with the spread of digital content (such as advertisement, news and electronic books) following development of a communication infrastructure, constant display of still images is requested to display images of the digital content on mobile information terminals such as mobile telephones and mobile internet devices (MID). Although such a mobile information terminal which displays digital content uses a liquid crystal display device with low power consumption, a time for displaying still images occupies a large part upon use of the terminal, and therefore lower power consumption is requested upon constant display of a still image.

According to the configurations disclosed in Patent Documents 1 and 2, when the buffer amplifier of the unity gain is ideal, the voltage is not applied between the source and the drain of the TFT forming the switch element arranged on the pixel electrode side, so that it is possible to suppress the leak current of the TFT. On the other hand, when a buffer amplifier formed with two or four TFTs disclosed in Patent Documents 1 and 2 is adopted, an accurate unity gain is not realized unless a threshold voltage of the TFTs forming the buffer amplifier is 0 V, so that leak currents of the TFTs forming the switching element are not sufficiently suppressed, and a pixel voltage held in the pixel voltage is likely to fluctuate. Furthermore, if the threshold voltage is closer to 0 V, power consumption becomes higher, thereby contradicting with a request for lower power consumption. Further, when the buffer amplifier of the unity gain is formed using an operational amplifier, not only a circuit scale increases, thereby contradicting with a request for lower power consumption, but also the ratio a circuit element area occupies in a pixel circuit is high, an aperture ratio in a transmissive mode decreases and brightness of a display image decreases.

In light of the above problem, it is therefore an object of the present invention to provide a pixel circuit and a display device which can support multiple tone display, and prevent a decrease in display quality with low power consumption.

### Means for Solving the Problem

In order to achieve the above object, the present invention provides a pixel circuit including:
a display element unit including a unit liquid crystal display element having a liquid crystal layer sandwiched between a pixel electrode and a counter electrode;
a capacitor element having a tunnel insulating film sandwiched between first and second electrodes, wherein an FN (Fowler-Nordheim) tunnel current flows between the first and second electrodes when a predetermined high voltage is applied between the first and second electrodes; and
a switch circuit having a first terminal, a second terminal, and a control terminal, the first terminal being connected to the second electrode of the capacitor element, the second terminal being connected to a data signal line, the control terminal being connected to a scanning signal line and controlling electrical connection between the first and second terminals,
wherein a voltage corresponding to pixel data with a voltage of the counter electrode being a reference is held in an internal node connecting the pixel electrode and the first electrode of the capacitor element.

Furthermore, the pixel circuit having the above characteristic is preferably configured such that the switch circuit includes a thin film transistor element having a first terminal, a second terminal, and a control terminal for controlling electrical connection between the first and second terminals.

Furthermore, the pixel circuit having the above characteristic may include an auxiliary capacitor element having one end connected to the internal node and the other end connected to the counter electrode or a predetermined control line.

Furthermore, in order to achieve the above object, the present invention provides a display device having a first characteristic that
a plurality of pixel circuits are arranged in a row direction and a column direction to form a pixel circuit array, each of the pixel circuits being the pixel circuit having the above characteristic,
data signal lines are provided for respective columns one by one,
scanning signal lines are provided for respective rows one by one,
the second terminals of the switch circuits in the pixel circuits arranged in the same column are connected to one of the data signal lines in common,
the control terminals of the switch circuits in the pixel circuits arranged in the same row are connected to one of the scanning signal lines in common, and
the display device includes:
a data signal line drive circuit individually driving the data signal lines;
a scanning signal line drive circuit individually driving the scanning signal lines, and
a counter electrode drive circuit driving the counter electrode.

Furthermore, the display device having the above first characteristic has a second characteristic that a plurality of counter electrodes are provided for the pixel circuit array, and one of the counter electrodes is shared by the plurality of pixel circuits in one or more rows, and
the counter electrode drive circuit individually drives the plurality of counter electrodes.

Furthermore, the display device having the above first or second characteristic is characterized in that,
upon a first writing operation of writing pixel data including two tones or more individually in the pixel circuits arranged in one selected row by supplying a voltage of a first polarity which is positive or negative to the internal node with the counter electrode being a reference,
upon a second writing operation of writing pixel data including two tones or more individually in the pixel circuits arranged in one selected row by supplying a voltage of a polarity opposite to the first polarity to the internal node with the counter electrode being a reference, or
upon an initialization operation of collectively returning the pixel circuits arranged in one or more selected rows to an initial state before pixel data including two tones or more is written,
the scanning signal line drive circuit applies a predetermined selected row voltage to the scanning signal line of the selected row to set the switch circuits of the pixel circuits arranged in the selected row to a conducting state, and applies a predetermined unselected row voltage to the scanning signal line in a row other than the selected row to set the switch circuits of the pixel circuits arranged in the row other than the selected row to a non-conducting state.

Furthermore, the display device having the first characteristic is characterized in that,
upon the first writing operation,
the data signal line drive circuit individually applies, to each of the data signal lines, a pixel data voltage corresponding to pixel data to be written in the pixel circuit in each column of the selected row, and the counter electrode drive circuit applies, to the counter electrode, a first write voltage having a polarity opposite to the first polarity with each of the data signal lines being a reference, and in the pixel circuits arranged in the selected row, the tunnel current is passed between the first and second electrodes of the capacitor element, and a voltage of the internal node with the counter electrode being a reference is raised when the first polarity is positive and is reduced when the first polarity is negative.

Furthermore, the display device having the first characteristic is characterized in that,
upon the second writing operation,
the data signal line drive circuit individually applies, to each of the data signal lines, a pixel data voltage having a polarity opposite to that of the pixel data voltage applied in the first writing operation and corresponding to pixel data to be written in the pixel circuit in each column of the selected row, and the counter electrode drive circuit applies, to the counter electrode, a second write voltage having the first polarity with each of the data signal lines being a reference, and in the pixel circuits arranged in the selected row, the tunnel current is passed between the first and second electrodes of the capacitor element, and a voltage of the internal node with the counter electrode being a reference is reduced when the first polarity is positive and is raised when the first polarity is negative.

Furthermore, the display device having the first characteristic is preferably configured such that the first writing operation and the second writing operation are alternately executed on the same pixel circuit.

Furthermore, the display device having the first characteristic is characterized in that,
upon the initialization operation,
the data signal line drive circuit applies a first initialization voltage to each of the data signal lines, the counter electrode drive circuit applies a second initialization voltage to the counter electrode, and in the pixel circuits arranged in the selected row, the tunnel current is passed between the first and second electrodes of the capacitor element, and a voltage of the internal node with the counter electrode being a reference is raised or reduced to initialize the pixel circuits.

Furthermore, the display device having the second characteristic is characterized in that,
upon the first writing operation,
the data signal line drive circuit individually applies, to each of the data signal lines, a pixel data voltage corresponding to pixel data to be written in the pixel circuit in each column of the selected row, and the counter electrode drive circuit applies, to the counter electrode of the selected row, a first write voltage having a polarity opposite to the first polarity with each of the data signal lines being a reference, and applies, to the counter electrode of a row other than the selected row, a predetermined unselected counter voltage, and in the pixel circuits arranged in the selected row, the tunnel current is passed between the first and second electrodes of the capacitor element, and a voltage of the internal node with the counter electrode being a reference is raised when the first polarity is positive and is reduced when the first polarity is negative.

Furthermore, the display device having the second characteristic is characterized in that,
upon the second writing operation,
the data signal line drive circuit individually applies, to each of the data signal lines, a pixel data voltage having a polarity opposite to that of the pixel data voltage applied in the first writing operation and corresponding to pixel data to be written in the pixel circuit in each column of the selected row, and the counter electrode drive circuit applies, to the counter electrode of the selected row, a second write voltage having the first polarity with each of the data signal lines being a reference, and applies, to the counter electrode of a row other than the selected row, a predetermined unselected counter voltage, and in the pixel circuits arranged in the selected row, the tunnel current is passed between the first and second electrodes of the capacitor element, and a voltage of the internal node with the counter electrode being a reference is reduced when the first polarity is positive and is raised when the first polarity is negative.

Furthermore, the display device having the second characteristic is preferably configured such that the first writing operation and the second writing operation are alternately executed on the same pixel circuit.

Furthermore, the display device having the second characteristic is characterized in that,
upon the initialization operation,
the data signal line drive circuit applies a first initialization voltage to each of the data signal lines, the counter electrode drive circuit applies a second initialization voltage to the counter electrode of the selected row, and applies a predetermined unselected counter voltage to the counter electrode of a row other than the selected row, and in the pixel circuits arranged in the selected row, the tunnel current is passed between the first and second electrodes of the capacitor element, and a voltage of the internal node with the counter electrode being a reference is raised or reduced to initialize the pixel circuits.

### EFFECT OF THE INVENTION

According to the pixel circuit and the display device having the above features, in any of the display modes of normal display and constant display, the switch circuit and the capacitor element are interposed between an internal node holding a voltage (pixel voltage) corresponding to pixel data with a voltage of a counter electrode being a reference and a data signal line for supplying a pixel data voltage that is set to correspond to the pixel data, and therefore, upon a writing operation (first or second writing operation) of pixel data from the data signal line to the internal node using the switch circuit, a high voltage causing FN (Fowler-Nordheim) tunnel phenomenon is applied to the tunnel insulating film, and electrical charge (electrons) are injected or extracted by a tunnel current corresponding to the pixel data voltage to/from the internal node through the switch circuit and the capacitor element, so that the pixel voltage corresponding to the pixel data can be set in the internal node. Further, in the normal display mode, by performing fine control of the pixel data voltage supplied to the data signal line, the amount of electrical charge held in the internal node can be controlled by adjusting the high voltage application condition where the above FN tunnel phenomenon is caused, and therefore, it is possible to write pixel data with a high tone of full color display by color display using three or more pixel circuits. Further, likewise, by controlling the voltage supplied to the data signal line in multiple tones even upon a constant display mode, it is possible to write pixel data of multiple tones in color display. In the present invention, the “tunnel insulating film” means an insulating film where a tunnel current (leak current) flows in the insulating film by a high electrical field generated by a predetermined high voltage application condition. In this case, the tunnel current includes an FN tunnel current generated when the effective film thickness of the insulating film becomes further thinner than the physical film thickness due to the high electrical field which increases the probability of occurrence of the tunnel current to cause an FN tunnel phenomenon, and also includes a PF current due to PF (Pool-Frenkel) effect.

Further, the counter electrode and the pixel electrode are insulated with the liquid crystal layer interposed therebetween and an unit liquid crystal display element functions as an electrical capacitance, and since the internal node is electrically insulated by the capacitor element and the unit liquid crystal display element from the data signal line, the scanning signal line, and the counter electrode, the electrical charge held in the internal node is held in a non-volatile manner even when the power supply to the display device and the pixel circuit is turned off, and therefore, after the power supply is recovered, the image display before the power supply is turned off can be reproduced without refreshing the pixel circuit.

In addition, the pixel circuit according to the present invention forms a sub pixel which is a minimum display unit and corresponds to each color of three primary colors (RGB) in case of color display. Hence, in case of color display, pixel data is individual tone data of three primary colors. In addition, when one pixel is displayed by adding a color (or monochromatically) other than the three primary colors, a sub pixel is formed for the added color.

Further, under the voltage application condition where the above tunnel phenomenon does not occur, the internal node and the switch circuit are insulated and separated by the capacitor element, and therefore, this eliminates change of the pixel voltage held in the internal node caused by a leak current of a transistor element and the like constituting the switch circuit, and the written pixel data are held in the internal node in a stable manner, and it is possible to prevent reduction of the quality of display due to the voltage change.

Further, as compared with a conventional configuration having a buffer amplifier provided in a pixel circuit to suppress change of the voltage of an internal node illustrated in FIGS. 18 and 19, the pixel circuit having each of the above features may have a less number of elements, and can solve the problem of the decrease of the aperture ratio, prevent increase of power consumption in the buffer amplifier, and prevent reduction of the quality of display due to the decrease of the aperture ratio, thus reducing the power consumption.

### BRIEF DESCRIPTION OF THE DRAWINGS

FIG. 1 is a block diagram illustrating an example (configuration A) of a schematic configuration of a display device according to the present invention.

FIG. 2 is a block diagram illustrating another example (configuration B) of a schematic configuration of a display device according to the present invention.

FIG. 3 is a partial cross-sectional schematic structure diagram of a liquid crystal display device.

FIG. 4 is a circuit diagram illustrating a basic circuit configuration of a pixel circuit according to the present invention.

FIG. 5 is a partial cross sectional schematic structure diagram schematically illustrating a cross sectional structure of an essential portion of a pixel circuit of the present invention.

FIG. 6 is a transmittance characteristics diagram schematically illustrating a relationship between the pixel voltage and the transmittance of the unit liquid crystal display element.

FIG. 7 is a circuit diagram schematically illustrating two rows by two columns of a pixel circuit array of the display device illustrated in FIG. 1.

FIG. 8 is a timing chart schematically illustrating an example of voltage application waveform of each operation in a normal display mode to the display device illustrated in FIG. 1.

FIG. 9 is a timing chart schematically illustrating an example of voltage application waveform of each operation in a constant display mode to the display device illustrated in FIG. 1.

FIG. 10 is a timing chart schematically illustrating another example of voltage application waveform of each operation in a constant display mode to the display device illustrated in FIG. 1.

FIG. 11 is a circuit diagram schematically illustrating two rows by two columns of a pixel circuit array of the display device illustrated in FIG. 2.

FIG. 12 is a timing chart schematically illustrating an example of voltage application waveform of each operation in a normal display mode to the display device illustrated in FIG. 2.

FIG. 13 is a timing chart schematically illustrating an example of voltage application waveform of each operation in a constant display mode to the display device illustrated in FIG. 2.

FIG. 14 is a timing chart schematically illustrating another example of voltage application waveform of each operation in a constant display mode to the display device illustrated in FIG. 2.

FIG. 15 is a circuit diagram illustrating another embodiment of a basic circuit configuration of the pixel circuit according to the present invention.

FIG. 16 illustrates an equivalent circuit of a pixel circuit of a common active matrix liquid crystal display device.

FIG. 17 is a block diagram illustrating an example of a circuit arrangement in an active matrix liquid display device of m x n pixels.

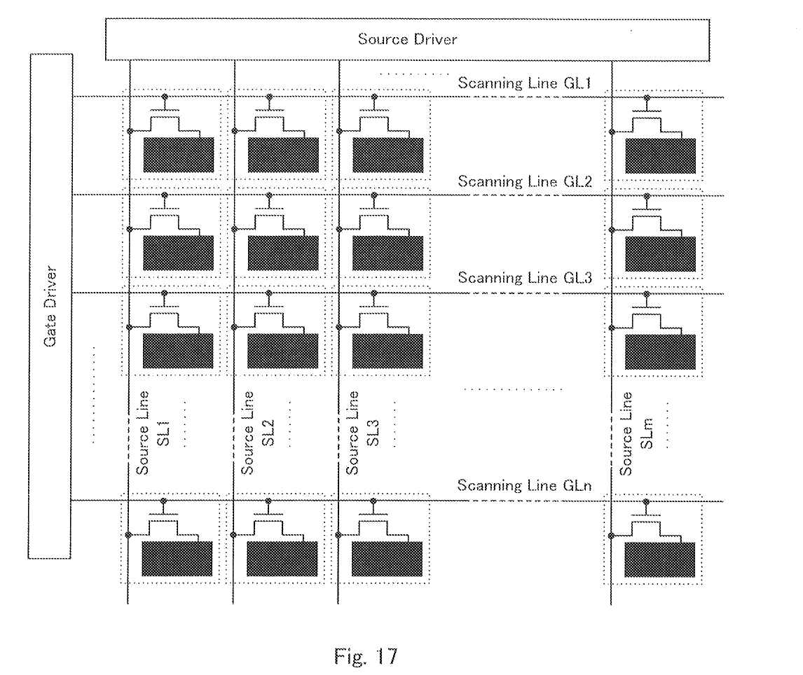

FIG. 18 is an equivalent circuit diagram illustrating an example of a conventional pixel circuit having a buffer amplifier of a unity gain.

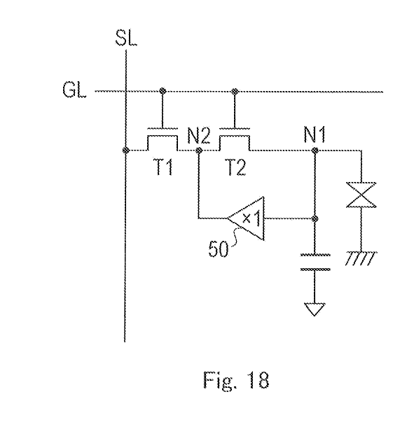

FIG. 19 is an equivalent circuit diagram illustrating another example of a conventional pixel circuit having a buffer amplifier of a unity gain.

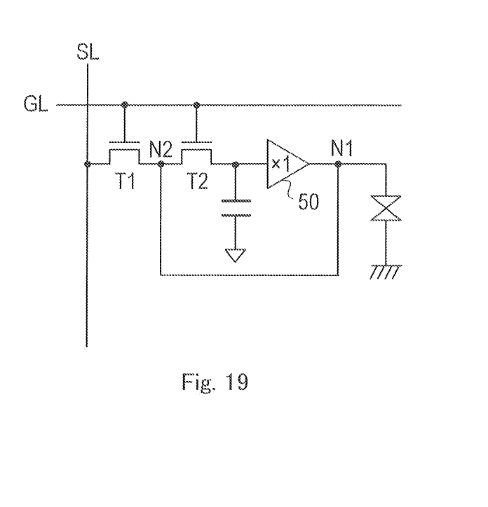

### MODE FOR CARRYING OUT THE INVENTION

Each embodiment of a pixel circuit and a display device according to the present invention will be described below with reference to the drawings.

### First Embodiment

In the first embodiment, a display device according to the present invention (hereinafter, simply “display device”) and a circuit configuration of a pixel circuit according to the present invention (hereinafter, “pixel circuit”) will be described.

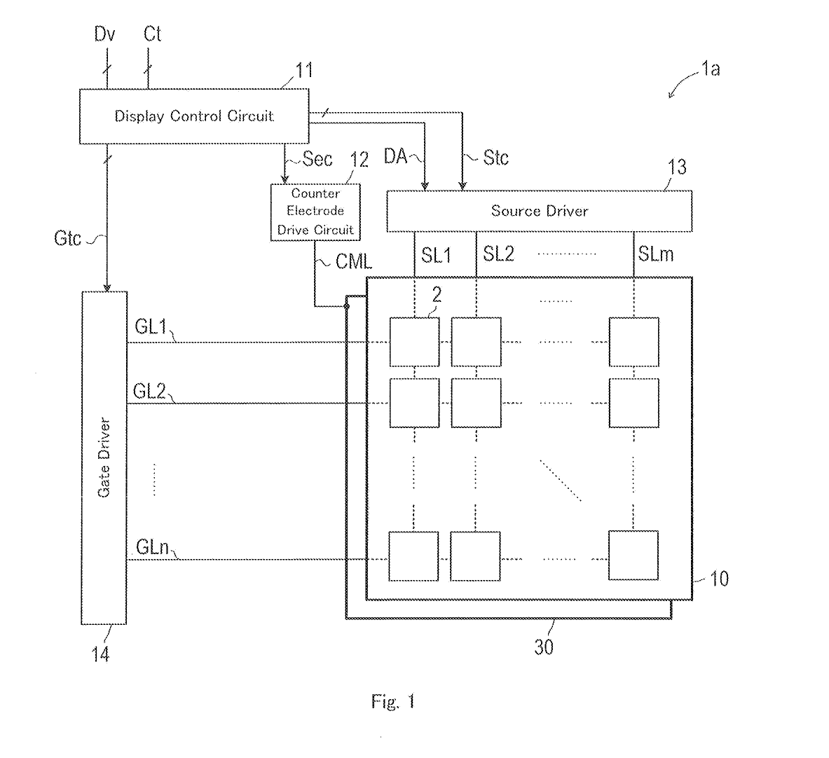

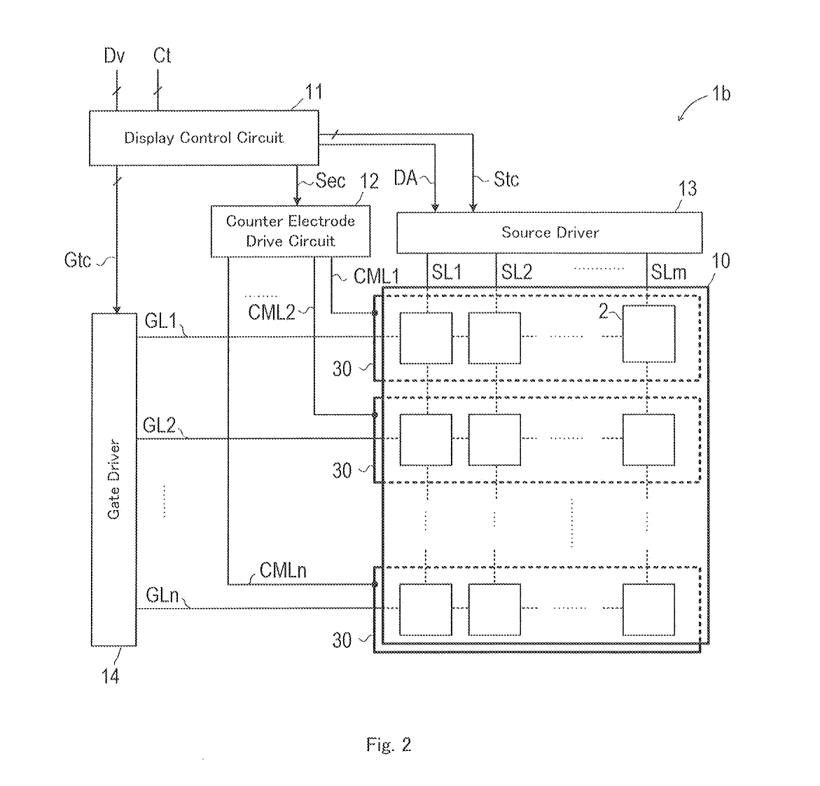

In the present embodiment, the display device 1 has two configurations (configuration A and configuration B) each using a pixel circuit 2 having a single basic circuit configuration. FIG. 1 illustrates a schematic configuration of a display device 1a of the configuration A. FIG. 2 illustrates a schematic configuration of a display device 1b of the configuration B.

Each of the display devices 1a and 1b has an active matrix substrate 10, a counter electrode 30, a display control circuit 11, a counter electrode drive circuit 12, a source driver 13, a gate driver 14 and various signal lines described below. On the active matrix substrate 10, a plurality of pixel circuits 2 are arranged in a row direction and a column direction to form a pixel circuit array. In addition, in FIGS. 1 and 2, the pixel circuits 2 are displayed in block units to avoid complication of drawings. Further, FIGS. 1 and 2 illustrate the active matrix substrate 10 above the counter electrode 30 for the sake of convenience to clearly display that various signal lines are formed on the active matrix substrate 10.

According to the present embodiment, the display device 1 employs a configuration which can display a screen in two display modes of a normal display mode and a constant display mode using the same pixel circuit 2. The normal display mode is a display mode which displays a movie or a still image in full color display, and uses transmissive liquid crystal display using a backlight. Meanwhile, the constant display mode is a display mode which displays n tones (n≧2 and, for example, n=4) for each pixel circuit, and allocates three adjacent pixel circuits 2 to each color of three primary colors (R, G and B) and displays 64 colors (in case of n=4). Further, in the constant display mode, it is possible to further combine a plurality of sets of three adjacent pixel circuits and increase the number of display colors by area coverage modulation. However, in the present embodiment, in any of the normal display mode and the constant display mode, all the constituent elements of the pixel circuits 2 are used to write pixel data according to the same writing operation, and therefore, it is not necessary to separately consider the normal display mode and the constant display mode. However, in the normal display mode, the “counter AC driving” described above is executed in units of rows, but in the constant display mode, it is not necessary to execute the “counter AC driving” in units of rows, and therefore, in the present embodiment, two display modes can be distinguished from each other in accordance with the way the “counter AC driving” is executed.

In addition, in the following description, for the sake of convenience, a minimum display unit corresponding to one pixel circuit 2 is referred to as a “pixel”, and “pixel data” to be written in each pixel circuit is tone data of each color in case of color display using three primary colors (R, G and B). In addition, upon color display including another color (for example, yellow) and brightness data of black and white in addition to three primary colors, tone data of this another color and brightness data are also included in pixel data.

As described later, the display device 1 is characterized by the circuit configuration of the pixel circuit 2, and the circuit configuration is compatible with both of the normal display mode and the constant display mode, and therefore, as a matter of course, this can also be applied to a configuration where the normal display mode and the constant display mode are not used together and only one of the normal display mode and the constant display mode is used to perform liquid crystal display.

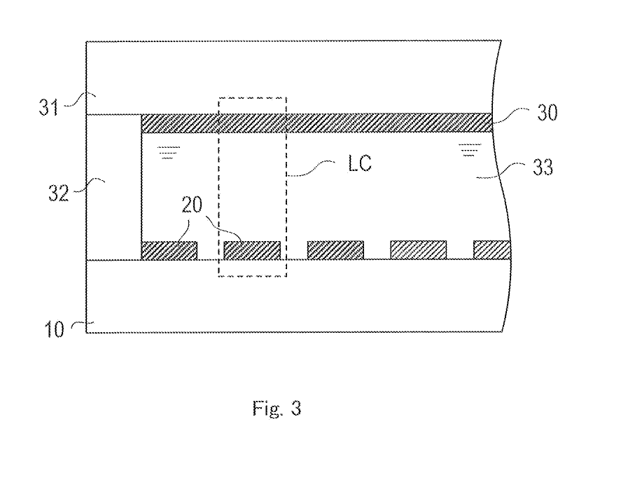

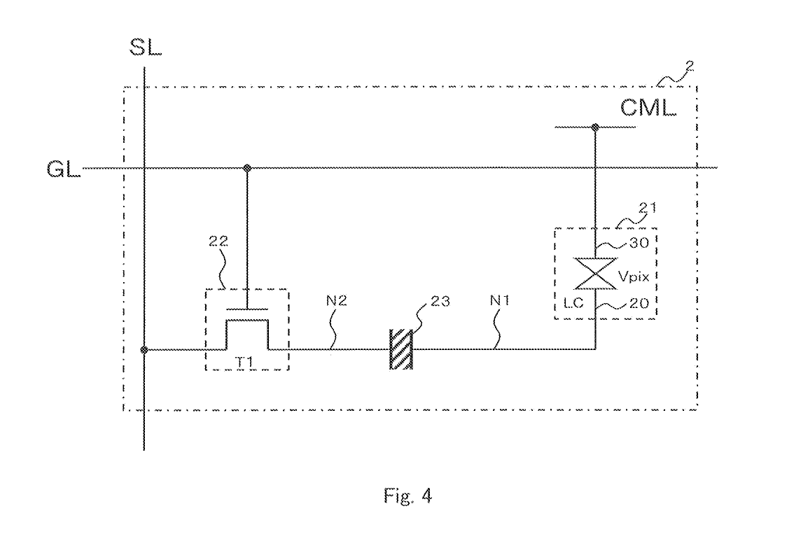

FIG. 3 is a schematic cross-sectional structure diagram illustrating a relationship between the active matrix substrate 10 and the counter electrode 30, and illustrates a structure of a display element unit 21 (see FIG. 4) which is a component of the pixel circuit 2. The active matrix substrate 10 is an optically transmissive transparent substrate, and is made of, for example, glass or plastic. As illustrated in FIGS. 1 and 2, the pixel circuits 2 including each signal line are formed on the active matrix substrate 10. FIG. 3 illustrates pixel electrodes 20 which represent components of the pixel circuit 2. The pixel electrode 20 is made of an optically transmissive transparent conductive material such as ITO (indium tin oxide).

An optically transmissive counter substrate 31 is arranged to oppose to the active matrix substrate 10, and a liquid crystal layer 33 is held in a gap between these substrates. Polarizing plates (not illustrated) are attached to outer surfaces of both surfaces.

The liquid crystal layer 33 is sealed by a sealing member 32 in a peripheral portion of both substrates. On the counter substrate 31, the counter electrode 30 which is made of an optically transmissive transparent conductive material such as ITO is formed to oppose to the pixel electrodes 20. This counter electrode 30 is formed as a single film to spread substantially over the counter substrate 31 in the display device 1a of the configuration A. Meanwhile, one pixel electrode 20, the counter electrode 30 and the liquid crystal layer 33 sandwiched therebetween form a unit liquid crystal display element LC (see FIG. 4). As illustrated in FIG. 2, in the display device 1b of the configuration B, counter electrodes 30 are formed in such a manner that they are divided into rectangular shapes for each row of the pixel circuit array, and there are as many counter electrodes 30 as the number of the rows. A single counter electrode 30 is shared by multiple pixel circuits 2 in the same row as the counter electrode 30.

In addition, a backlight device (not illustrated) is arranged on a back surface side of the active matrix substrate 10, and can emit light in a direction from the active matrix substrate 10 to the counter substrate 31.

As illustrated in FIGS. 1 and 2, a plurality of signal lines are formed on the active matrix substrate 10 in vertical and horizontal directions. Further, in both of the display device 1a of the configuration A and the display device 1b of the configuration B, a plurality of pixel circuits 2 are formed in a matrix pattern at portions at which m source lines (SL1, SL2, . . . and SLm) extending in the vertical direction (column direction) and n gate lines (GL1, GL2, . . . and GLn) extending in the horizontal direction (row direction) to form the pixel circuit array. In addition, m and n are the number of columns and the number of rows, and are natural numbers equal to or more than 2, respectively. In addition, for the sake of convenience, each source line (SL1, SL2, . . . and SLm) is collectively referred to as the “source line SL”, and each gate line (GL1, GL2, . . . and GLn) is collectively referred to as the “gate line GL”. The voltage corresponding to an image to be displayed is applied to the pixel electrode 20 formed in each pixel circuit 2 from the source driver 13 and the gate driver 14 through the source lines SL and the gate lines GL.

The source line SL corresponds to the “data signal line”, and the gate line GL corresponds to the “scan signal line”. The source driver 13 corresponds to a “data signal line drive circuit”, and the gate driver 14 corresponds to a “scan signal line drive circuit”.

The display control circuit 11 is a circuit which controls each of the first writing operation, the second writing operation, and the initialization operation in the normal display mode and the constant display mode described below. The respective operations will be described in detail in the second embodiment. Upon the writing operation (the first and second operations), the display control circuit 11 receives a data signal Dv showing an image to be displayed and a timing signal Ct from an external signal source, and generates a digital image signal DA and a data side timing control signal Stc given to the source driver 13, a scan side timing control signal Gtc given to the gate driver 14, and a counter voltage control signal Sec given to the counter electrode drive circuit 12, based on the signals Dv and Ct, as signals for displaying an image on the display element unit 21 of the pixel circuit array. Upon the initialization operation, the display control circuit 11 performs the same operation as during the writing operation except that the display control circuit 11 does not generate the digital image signal DA to the source driver 13. In addition, part or the entirety of the display control circuit 11 is preferably formed in the source driver 13 or the gate driver 14.

The source driver 13 is a circuit which applies source signals of a predetermined timing and a predetermined voltage value to each source line SL upon each of the above operations according to control by the display control circuit 11. Upon the writing operation, the source driver 13 generates pixel data voltages which are appropriate for a voltage level of a counter voltage Vcom and respectively correspond to pixel values of one display line shown by a digital signal DA, based on the digital image signal DA and the data side timing control signal Stc, for each horizontal period (also referred to as “1H period”), as source signals Sc1, Sc2, . . . and Scm. The pixel data voltages are an analog voltage of multiple tones (a plurality of mutually discrete voltage values) according to the normal display mode and the constant display mode. Further, the source driver 13 applies these source signals to the corresponding source lines SL1, SL2, . . . and SLm, respectively. Furthermore, upon the initialization operation, the source driver 13 generates predetermined first initialization voltages as source signals Sc1, Sc2, . . . and Scm, and applies these source signals to the corresponding source lines SL1, SL2, . . . and SLm, respectively.

The gate driver 14 is a circuit which applies the gate signal of a predetermined timing and a predetermined voltage amplitude to each gate line GL upon each of the operations according to control by the display control circuit 11. Upon the writing operation, the gate driver 14 sequentially selects the gate lines GL1, GL2, . . . and GLn substantially for one horizontal period in each frame period of the digital image signal DA and sequentially activates the pixel circuits 2 of each row in order to write the pixel data each corresponding to the source signals Sc1, Sc2, . . . and Scm to the respective pixel circuits 2 based on the scan side timing control signal Gtc. Upon an initialization operation, in order to initialize each pixel circuit 2 based on the scan side timing control signal Gtc, the gate driver 14 performs as follows. In one frame period, the gate driver 14 sequentially selects the gate lines GL1, GL2, . . . , and GLn substantially for one horizontal period and sequentially activates the pixel circuits 2 of each row, or in a predetermined period within one frame period, the gate driver 14 selects the gate lines GL1, GL2, . . . , and GLn at a time, and collectively activates all the pixel circuits 2 which are to be initialized. In addition, the gate driver 14 may be formed on the active matrix substrate 10 similar to the pixel circuit 2.

The counter electrode drive circuit 12 applies the counter voltage V30 to the counter electrode 30 through the counter electrode wiring CML. In display device 1b of the configuration B, the counter electrode drive circuit 12 drives the counter electrodes 30 through counter electrode wirings CML (CML1, CML2, . . . , and CMLn) in units of one or more rows. In the display devices 1a and 1b of the configuration A and the configuration B, the counter electrodes 30 are used for control of the writing operation and the initialization operation which will be described later, and therefore, different voltages are applied in accordance with operation modes. These applications of voltages will be described later. In the display device 1b of the configuration B, the counter electrodes 30 corresponding to the rows are driven in units of rows, and therefore, the counter electrode drive circuit 12 and the gate driver 14 may be integrally formed.

Next, a configuration of the pixel circuit 2 will be described with reference to FIG. 4. As illustrated in FIG. 4, the pixel circuit 2 includes the display element unit 21 including the unit liquid crystal display element LC, a switch circuit 22, and a capacitor element 23. An internal node N1 is formed by connecting a first electrode of the capacitor element 23 and a pixel electrode 20. An internal node N2 is formed by connecting a first terminal of the switch circuit 22 and a second electrode of the capacitor element 23. The switch circuit 22 has the second terminal connected to the source line SL and a control terminal for controlling electrical connection of the switch circuit 22 connected to the gate line GL. The capacitor element 23 is configured such that a tunnel insulating film made of a thin insulating film (for example, silicon oxide film) having a thickness of about 50 nm is sandwiched between the first electrode and the second electrode. As illustrated in FIG. 4, in the present embodiment, the switch circuit 22 is made of a single transistor T1. The transistor T1 is a thin film transistor such as a polysilicon TFT or an amorphous silicon TFT formed on the active matrix substrate 10, and one of the first and second terminals corresponds to a drain electrode, the other thereof corresponds to a source electrode and a control terminal corresponds to a gate electrode. The switch circuit 22 may be made of the single transistor T1, but it may be made of a plurality of transistors connected in series, in which the control terminal is shared. In addition, the following description of the operation of the pixel circuit 2 assumes that the transistor T1 is an N channel type polysilicon TFT, and the threshold voltage is about 2 V.

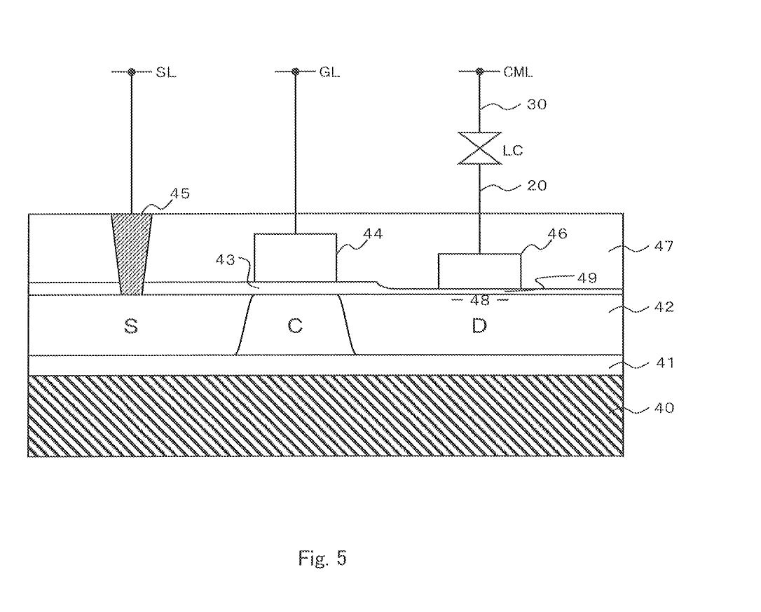

FIG. 5 schematically illustrates a cross sectional structure of the transistor T1 and the capacitor element 23 of the pixel circuit 2. A buffer layer 41 of the insulating film is formed on a glass substrate 40, and on the buffer layer 41, a polycrystalline silicon region 42 constituting a source electrode S, a drain electrode D, and a channel region C of the transistor T1, a gate insulating film 43 covering the polycrystalline silicon region 42, a gate electrode 44, a source electrode 45, the first electrode 46 of the capacitor element 23, and an interlayer insulating film 47 are formed. Each of the gate electrode 44, the source electrode 45, and the first electrode 46 of the capacitor element 23 is constituted by a metal film (metal material). In the configuration of FIG. 5, the drain D of the transistor T1 and the second electrode 48 of the capacitor element 23 are integrally formed. The gate electrode 44 is connected to the gate line GL, and the source electrode 45 is connected to the source line SL. The first electrode 46 is connected to the pixel electrode 20 of the unit liquid crystal display element LC. In FIG. 5, the unit liquid crystal display element LC is shown schematically made into a symbol. The unit liquid crystal display element LC is as described with reference to FIG. 3, and therefore will not be described.

The capacitor element 23 is configured such that the tunnel insulating film 49 having the thin film thickness is sandwiched between the first electrode 46 and the second electrode 48, and accordingly, when a predetermined high voltage is applied between the first electrode 46 and the second electrode 48, an FN (Fowler-Nordheim) tunnel current is passed, and this makes it possible to take electrical charge (electrons) in/out of the internal node N1, i.e., to inject/extract electrical charge (electrons) into/from the internal node N1, from the second electrode 48. In the present embodiment, writing and initialization of the pixel data in the internal node N1 are performed with the tunnel current. The first writing operation and the second writing operation are distinguished from each other by controlling the direction of the injection/extraction of the electrical charge with the polarity of the high voltage applied between the first electrode 46 and the second electrode 48, and the amount of injection and the amount of extraction of electrical charge are controlled with the voltage value of the high voltage. The voltage difference between a voltage V20 held in the internal node N1 (pixel electrode 20) and a voltage V30 applied to the counter electrode 30 is applied, as a pixel voltage Vpix (=|V20−V30|), to the unit liquid crystal display element LC, and the transmittance of the unit liquid crystal display element LC is determined.

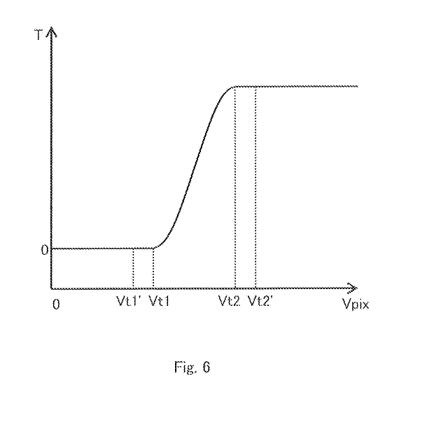

FIG. 6 schematically illustrates a relationship of the transmittance T of the unit liquid crystal display element LC and the pixel voltage Vpix (=|V20−V30|). In the transmittance characteristics illustrated in FIG. 6, the lower limit value and the upper limit value of the voltage range of the pixel voltage Vpix where the transmittance T monotonically changes in accordance with the change of the pixel voltage Vpix will be referred to as a first threshold voltage Vt1 and a second threshold voltage Vt2, respectively. In each pixel circuit 2 after the first and second writing operations described later, the pixel voltage Vpix is controlled within the range of Vt1′≦Vpix≦Vt2′. In this case, the lower limit value Vt1′ is the same as the first threshold voltage Vt1 or a value slightly smaller than the first threshold voltage Vt1, and the upper limit value Vt2′ is the same as the second threshold voltage Vt2 or a value slightly larger than the second threshold voltage Vt2. In the following description about the present embodiment, a description will be made while the following relationship is assumed: 0<Vt1′≦Vt1<Vt2≦Vt2′.

In the pixel circuit 2, the voltage is applied to the first electrode 46 as follows. Since the first electrode 46 (internal node N1, pixel electrode 20) is in the floating state, the voltage is applied through the unit liquid crystal display element LC from the side of the counter electrode 30. More specifically, the voltage is applied by capacitive coupling. On the other hand, the voltage is applied to the second electrode 48 from the source line SL through the transistor T1.

### Second Embodiment

In a second embodiment, three operation modes, i.e., an initialization operation, first and second writing operations, and a pixel data holding operation of the display device 1 described in the first embodiment will be described.

The initialization operation is an operation for collectively making the pixel circuits arranged in one or more selected rows into a predetermined initial state before the writing operation. In the present embodiment, the initialization operation is collectively executed on pixel circuits in multiple selected rows or all of the pixel circuits of the pixel circuit array before the first or second writing operation that is executed on the pixel circuit array for the first time. It is sufficient to execute the initialization operation on a pixel circuit 2 only once before the first or second writing operation is executed for the first time, and the pixel circuit 2 stores the written pixel data in a non-volatile manner, and therefore, it is not necessary to execute the initialization operation every time the display device 1 is activated.

The first and second writing operations are operations for writing pixel data including two tones or more individually in pixel circuits 2 arranged in one selected row, and in the first writing operation, a voltage (pixel voltage Vpix) of a first polarity, i.e., either positive or negative polarity, is set in the internal node N1 with the counter electrode 30 being the reference, and in the second writing operation, a voltage (pixel voltage −Vpix) having a polarity opposite to the first polarity is set in the internal node N1 with the counter electrode 30 being the reference. In the present embodiment, the first polarity is considered to be a positive polarity, but if it is a negative polarity, this means that the first writing operation and the second writing operation are simply switched.

The pixel data holding operation is an operation other than the initialization operation and the first and second writing operations, and is an operation for holding the voltage state of the internal node N1 after the initialization operation or the first or second writing operation. In the description below, in the pixel data holding operation, regardless of the configuration of the display device 1, voltages are applied as follows. A data holding row voltage Vgh (for example, 0 V) is applied to all of the gate lines GL, a data holding column voltage Vsh (for example, 0 V) is applied to all of the source lines SL, and a data holding counter voltage Vch (for example, 0 V) is applied to the counter electrodes 30. More specifically, all the gate lines GL, all the source lines SL, and the counter electrodes 30 are set at the same voltage. In the description below, the voltage is 0 V.

In the present embodiment, when a pixel circuit 2 in a certain row is considered, first, the initialization operation is executed from the voltage application state upon the pixel data holding operation, and thereafter, the pixel data holding operation is executed, then the first (or second) writing operation is executed, and thereafter, the pixel data holding operation is executed, and the second (or first) writing operation is executed. After that, the first (or second) writing operation and the second (or first) writing operation are repeated. It should be noted that while the first and second writing operations are repeated, the pixel data holding operation always exists between the first and second writing operations, but in a still picture display mode, the time interval between the first and second writing operations is a period (refresh period) required to rewrite the pixel data of the still picture, which is longer than one frame period, and in the motion picture display mode, it is one frame period. However, in the still picture display mode, the pixel data to be written after the refresh period may be pixel data for changing the entire still picture displayed, pixel data for changing only a portion, or the same pixel data as the displayed still picture.

The first and second writing operations are as follows. In the normal display mode, within a certain frame period, the first and second writing operations are executed while the first and second writing operations are switched on every horizontal period (i.e., in units of rows), and in a subsequent frame period, the first and second writing operations are switched for the same row, and the first and second writing operations are executed while the first and second writing operations are switched on every horizontal period, and thereafter, in the motion picture display mode, every time the frame is changed, the first and second writing operations are switched for the same row, and the same operation is repeated (counter AC driving in units of rows). On the other hand, in the constant display mode, within a certain one frame period, any one of the writing operations is continuously executed throughout one frame period without switching the first and second writing operations on every horizontal period (i.e., in units of rows), and in one frame period of subsequent writing operation, the first and second writing operations are switched, and the writing operation is continuously executed, and thereafter, in the motion picture display mode, every time the frame is changed, the first and second writing operations are switched, and the same operation is repeated (counter AC driving in units of frames), and in the still picture display mode, every time the refresh period passes, the first and second writing operations are switched, and the same operation is repeated (counter AC driving in units of frames).

Hereinafter, each of the above operations will be described for each of the configurations of the display device 1. In the description about the operation described below, motion picture display in the normal display mode is assumed, and a description is added for cases of still picture display and motion picture display in the constant display mode.

### <<Display Device of the Configuration A>>

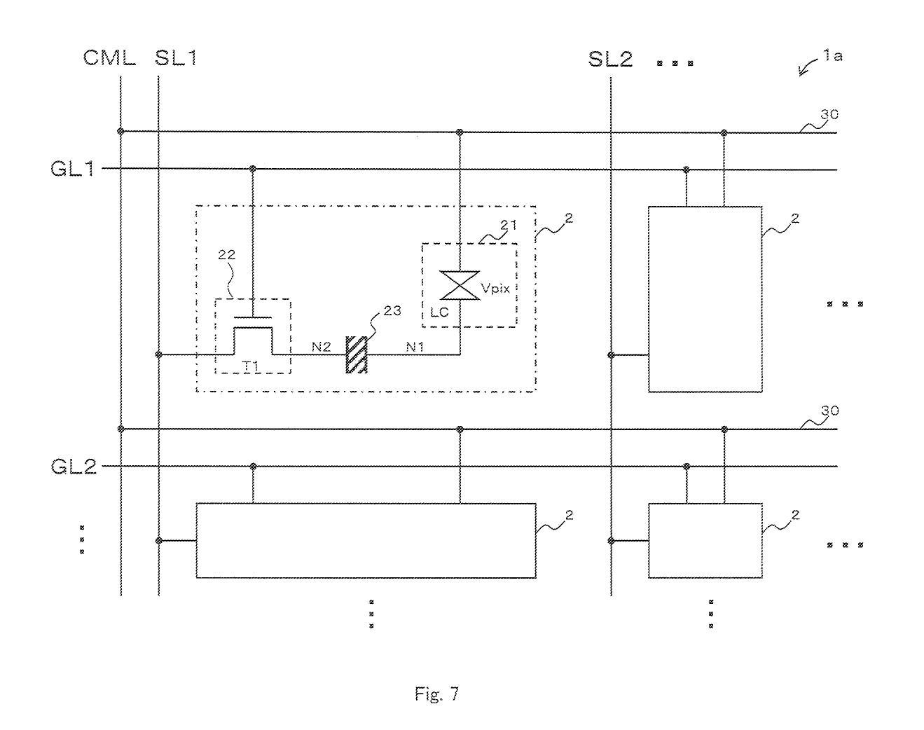

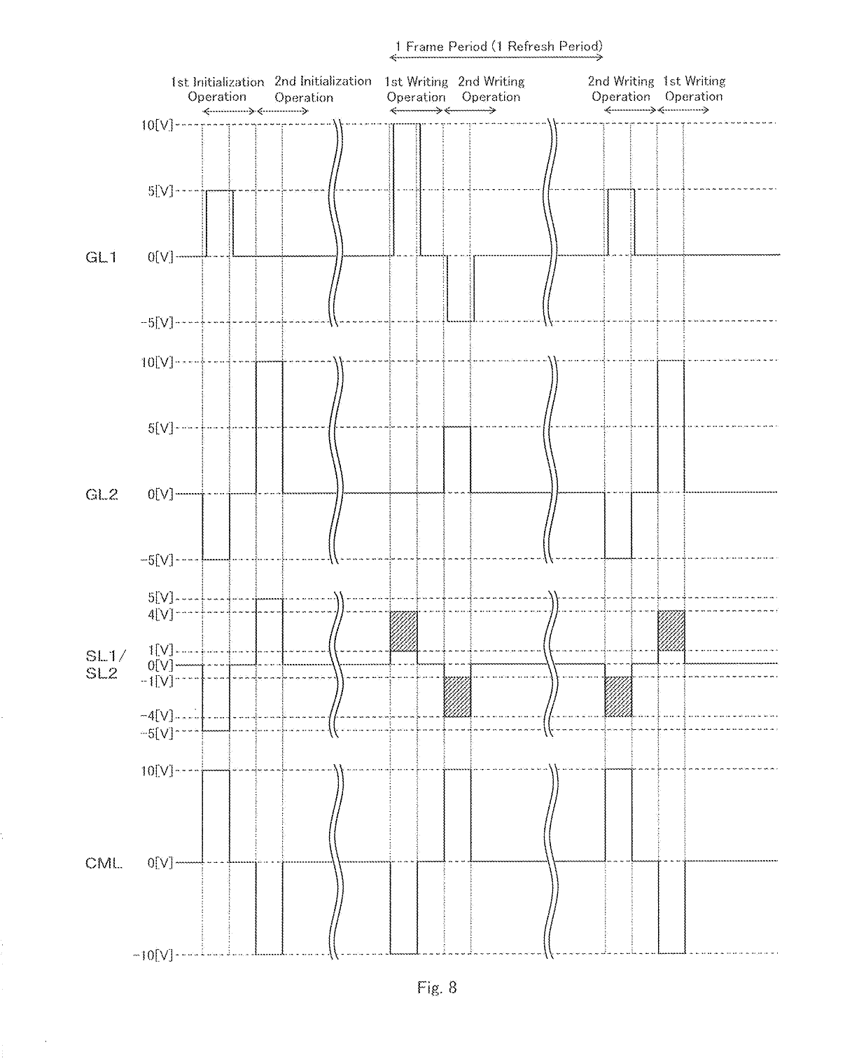

FIG. 7 schematically illustrates a portion of two rows by two columns of the pixel circuit array of the display device 1a of the configuration A. FIG. 8 schematically illustrates a voltage application waveform of each operation in a normal display mode to the display device 1a. Hereinafter, the gate line GL1 and the gate line GL2 will be described in a case where, in the initialization operation, the odd-numbered gate lines GL and the even-numbered gate lines GL of the n gate lines GL are selected in order, and in the writing operation, the n gate lines GL are selected row by row in the order of the arrangement, and (n−1) gate lines GL which are not selected are unselected.

### <<Initialization Operation and Writing Operation>>

In the writing operation of the normal display mode, the counter AC driving is executed on every horizontal period, and the polarity of the pixel voltage Vpix is reversed on every row. When the writing operation executed first is the first writing operation in the odd-numbered row, the second writing operation is executed in the even-numbered row. Therefore, the initialization operation is also divided into odd-numbered rows and even-numbered rows, and is executed in two steps, i.e., the first initialization operation for the first writing operation and the second initialization operation for the second writing operation. Hereinafter, it is assumed that, in the writing operation that is executed first, the first writing operation is executed in the odd-numbered rows, and the second writing operation is executed in the even-numbered rows.

### <<First Initialization Operation>>

In the first writing operation, after the writing operation, V20>V30 holds, and accordingly, in the first initialization operation, V20<V30 and Vpix>Vt2 are set as the initial state, and in order to attain the initial state, electrons are injected from the internal node N2 to the internal node N1 with the tunnel current flowing through the tunnel insulating film 49 of the capacitor element 23. For this reason, in the first initialization operation, for example, a selected row voltage Vg1 (for example, 5 V) is applied to all the gate lines GL of the odd-numbered rows, an unselected row voltage Vg0 (for example, −5 V) is applied to all the gate lines GL of the even-numbered rows, a negative voltage −Vsi1 (for example, −5 V) is applied to all the source lines SL, and a positive voltage Vci1 (for example, +10 V) is applied to the counter electrode 30, so that a high voltage +Vi1 which is positive with respect to the second electrode (internal node N2) is applied to the first electrode (internal node N1) of the capacitor element 23. In this case, the negative voltage −Vsi1 corresponds to the first initialization voltage, and the positive voltage Vci1 corresponds to the second initialization voltage.

In the above voltage application state, in all the pixel circuits 2 of the odd-numbered rows, the transistor T1 (switch circuit 22) is in the ON state, and the negative voltage −Vsi1 applied to the source line SL is applied to the second electrode (internal node N2) of the capacitor element 23. In all the pixel circuits 2 of the even-numbered rows, the transistor T1 (switch circuit 22) is in the OFF state, and the second electrode (internal node N2) of the capacitor element 23 is in the floating state.

The voltage V30 applied to the counter electrode 30 changes from the data holding counter voltage Vch (0 V) to Vci1, and therefore, the voltage V20 applied to the first electrode (internal node N1) of the capacitor element 23 is given by equation 2 below. Cw denotes an electrical capacitance between the first and second electrodes of the capacitor element 23. Clc denotes an electrical capacitance between the pixel electrode 20 and the counter electrode 30 of the unit liquid crystal display element LC. Q0′ denotes the amount of electrical charge held in the capacitor element 23 of the amount of electrical charge Q0 held in the internal node N1 before the first initialization operation. In the present embodiment, Clc>>Cw holds, and Clc is expected to be at a level about 1000 times larger than Cw, and the second term at the right hand side of equation 2, Clc/(Cw+Clc), can be approximated as one, and Q0' can be approximated as Q0. Equation 2 is approximately expressed as equation 3 in view of Vch=0 V and Clc>>Cw.

V20=Clc×Q0′+(Vci1−Vch)×Clc/(Cw+Clc) <Equation 2>

V20=Clc×Q0+Vci1 <Equation 3>

The first terms at the right hand sides of equation 2 and equation 3, Clc×Q0′ and Clc×Q0, are the voltage V20 of the internal node N1 before the first initialization operation. Therefore, in the pixel circuits 2 of the odd-numbered rows, the voltage Vi1 applied between the first and second electrodes of the capacitor element 23 (between the internal nodes N1 and N2) is given as equation 4 below, which is derived from equation 3 described above.

Vi1=Vci1+Vsi1+Clc×Q0 <Equation 4>

For example, a description will be made supposing that Q0 is 0. When the positive voltage (Vci1+Vsi1) applied between the first and second electrodes of the capacitor element 23 is a voltage high enough to generate the FN tunnel current, the FN tunnel current flows from the internal node N1 to the internal node N2, and the electrons (negative electrical charge) are injected from the internal node N2 into the internal node N1. As a result, the amount of positive electrical charge stored in the internal node N1 decreases, and the voltage at the internal node N1 decreases. In this case, when Q0>0 holds, the positive voltage (Vci1+Vsi1+Clc×Q0) applied between the first and second electrodes of the capacitor element 23 is a voltage higher than the case where Q0=0 holds, and this increases the amount of the FN tunnel current. On the contrary, when Q0<0 holds, the positive voltage (Vci1+Vsi1+Clc×Q0) applied between the first and second electrodes of the capacitor element 23 is a voltage lower than the case where Q0=0 holds, and this decreases the amount of the FN tunnel current. Therefore, a decrease in the amount of electrical charge held in the internal node N1 is larger as the amount of electrical charge Q0 before the initialization operation is larger, and the decrease in the amount of electrical charge held in the internal node N1 is smaller as the amount of electrical charge Q0 before the initialization operation is smaller, and therefore, the voltage V20′ of the internal node N1 after the FN tunnel current flows is substantially constant regardless of the amount of electrical charge Q0 before the first initialization operation. When the voltage applied to the counter electrode 30 is changed from the positive voltage Vci1 back to the data holding counter voltage Vch (0 V), the FN tunnel current is no longer generated, and the first initialization operation is terminated. When Clc>>Cw is considered to hold, a voltage V20″ of the internal node N1 after the first initialization operation is given by equation 5 below.

V20″=V20′−Vci1 <Equation 5>

The voltage V20′ at the right hand side of equation 5 is a voltage having a substantially constant value depending on the negative voltage −Vsi1 and the positive voltage Vci1, and therefore, the voltage V20″ in the internal node N1 after the first initialization operation is adjusted to satisfy V20<V30 (=Vch), Vpix (=|V20−V30|)>Vt2, by adjusting the negative voltage −Vsi1 and the positive voltage Vci1.

On the other hand, in the pixel circuits 2 of the even-numbered rows (unselected rows), the internal node N2 is in the floating state, and therefore, the voltage change of the internal node N1 becomes the voltage change of the internal node N2 due to the capacitive coupling through the capacitor element 23, and even when the voltage V30 applied to the counter electrode 30 changes from the data holding counter voltage Vch (0 V) to Vci1, the voltage applied between the first and second electrodes of the capacitor element 23 (between the internal nodes N1 and N2) does not change, and therefore, unlike the odd-numbered rows, the voltage V20 of the internal node N1 does not change, and the first initialization operation does not occur.

### <<Second Initialization Operation>>

Subsequently, the second initialization operation will be described. The second initialization operation is an operation in which the polarity of the voltage applied to each unit and the direction of the FN tunnel current are opposite to those of the first initialization operation.

In the second writing operation, after the writing operation, V20<V30 holds, and accordingly, in the second initialization operation, V20>V30 and Vpix>Vt2 are set as the initial state, and in order to attain the initial state, electrons are extracted from the internal node N1 to the internal node N2 with the tunnel current flowing through the tunnel insulating film 49 of the capacitor element 23. For this reason, in the second initialization operation, for example, a selected row voltage Vg1 (for example, 10 V) is applied to all the gate lines GL of the even-numbered rows, an unselected row voltage Vg0 (for example, 0 V) is applied to all the gate lines GL of the odd-numbered rows, a positive voltage Vsi2 (for example, +5 V) is applied to all the source lines SL, and a negative voltage −Vci2 (for example, −10 V) is applied to the counter electrode 30, so that a high voltage −Vi2 which is negative with respect to the second electrode (internal node N2) is applied to the first electrode (internal node N1) of the capacitor element 23. In this case, the positive voltage Vsi2 corresponds to the first initialization voltage, and the negative voltage −Vci2 corresponds to the second initialization voltage.

In the above voltage application state, in all the pixel circuits 2 of the even-numbered rows, the transistor T1 (switch circuit 22) is in the ON state, and the positive voltage Vsi2 applied to the source line SL is applied to the second electrode (internal node N2) of the capacitor element 23. In all the pixel circuits 2 of the odd-numbered rows, the transistor T1 (switch circuit 22) is in the OFF state, and the second electrode (internal node N2) of the capacitor element 23 is in the floating state.

The voltage V30 applied to the counter electrode 30 changes from the data holding counter voltage Vch (0 V) to −Vci2, and therefore, the voltage V20 applied to the first electrode (internal node N1) of the capacitor element 23 is given by equation 6 below. Cw denotes an electrical capacitance between the first and second electrodes of the capacitor element 23. Clc denotes an electrical capacitance between the pixel electrode 20 and the counter electrode 30 of the unit liquid crystal display element LC. Q1′ denotes the amount of electrical charge held in the capacitor element 23 of the amount of electrical charge Q1 held in the internal node N1 before the second initialization operation. In the present embodiment, Clc>>Cw holds, and Clc is expected to be at a level about 1000 times larger than Cw, and the second term at the right hand side of equation 6, Clc/(Cw+Clc), can be approximated as one, and Q1′ can be approximated as Q1. Equation 6 is approximately expressed as equation 7 in view of Vch=0 V, Clc>>Cw.

V20=Clc×Q1′−(Vci2+Vch)×Clc/(Cw+Clc) <Equation 6>

V20=Clc×Q1−Vci2 <Equation 7>

The first terms at the right hand sides of equation 6 and equation 7, Clc×Q1′ and Clc×Q1, are the voltage V20 of the internal node N1 before the second initialization operation. Therefore, in the pixel circuits 2 of the even-numbered rows, the voltage −Vi2 applied between the first and second electrodes of the capacitor element 23 (between the internal nodes N1 and N2) is given as equation 8 below, which is derived from equation 7 described above.

−Vi2=−Vci2−Vsi2+Clc×Q1 <Equation 8>

For example, a description will be made supposing that Q1 is 0. When the absolute value of the negative voltage (Vci2+Vsi2) applied between the first and second electrodes of the capacitor element 23 is a voltage high enough to generate the FN tunnel current, the FN tunnel current flows from the internal node N2 to the internal node N1, and the electrons (negative electrical charge) are extracted from the internal node N1 into the internal node N2. As a result, the amount of positive electrical charge held in the internal node N1 increases, and the voltage at the internal node N1 increases. In this case, when Q1>0 holds, the absolute value of the negative voltage (Vci1+Vsi1−Clc×Q1) applied between the first and second electrodes of the capacitor element 23 is a voltage lower than the case where Q1=0 holds, and this decreases the amount of the FN tunnel current. On the contrary, when Q1<0 holds, the absolute value of the negative voltage (Vci1+Vsi1−Clc×Q1) applied between the first and second electrodes of the capacitor element 23 is a voltage higher than the case where Q1=0 holds, and this increases the amount of the FN tunnel current. Therefore, an increase in the amount of electrical charge held in the internal node N1 is smaller as the amount of electrical charge Q1 before the initialization operation is larger, and the increase in the amount of electrical charge held in the internal node N1 is larger as the amount of electrical charge Q1 before the initialization operation is smaller, and therefore, the voltage V20′ of the internal node N1 after the FN tunnel current flows is substantially constant regardless of the amount of electrical charge Q1 before the second initialization operation. When the voltage applied to the counter electrode 30 is changed from the negative voltage −Vci2 back to the data holding counter voltage Vch (0 V), the FN tunnel current is no longer generated, and the second initialization operation is terminated. When Clc>>Cw is considered to hold, a voltage V20″ of the internal node N1 after the second initialization operation is given by equation 9 below.

V20″=V20′+Vci2 <Equation 9>

The voltage V20′ at the right hand side of equation 9 is a voltage having a substantially constant value depending on the positive voltage Vsi2 and the negative voltage −Vci2, and therefore, the voltage V20″ in the internal node N1 after the second initialization operation is adjusted to satisfy V20>V30 (=Vch), Vpix (=|V20−V30|)>Vt2, by adjusting the positive voltage Vsi2 and the negative voltage −Vci2.

On the other hand, in the pixel circuits 2 of the odd-numbered rows (unselected rows), the internal node N2 is in the floating state, and therefore, the voltage change of the internal node N1 becomes the voltage change of the internal node N2 due to the capacitive coupling through the capacitor element 23, and even when the voltage V30 applied to the counter electrode 30 changes from the data holding counter voltage Vch (0 V) to −Vci2, the voltage applied between the first and second electrodes of the capacitor element 23 (between the internal nodes N1 and N2) does not change, and therefore, unlike the even-numbered rows, the voltage V20 of the internal node N1 does not change, and the second initialization operation does not occur.

### <<First Writing Operation>>

Subsequently, the first writing operation will be described. The first writing operation is an operation in which the polarity of the voltage applied to each unit and the direction of the FN tunnel current is the same as those of the second initialization operation.

The pixel circuits 2 in the selected rows for the first writing operation are the pixel circuits 2 in the pixel data holding operation state after the first initialization operation or the second writing operation. If it is after the first initialization operation, then V20<V30 and Vpix>Vt2 hold, and if it is after the second writing operation, then V20<V30 and Vt1′≦Vpix≦Vt2′ hold. Therefore, the first writing operation is an operation for reversing the polarity of the pixel voltage Vpix of the internal node N1 from V20<V30 to V20>V30, and changing the absolute value thereof in accordance with the pixel data voltages provided to the source lines SL respectively connected to the selected pixel circuits 2. The reversing of the polarity of the pixel voltage Vpix and the change of the absolute value are operations for increasing the voltage V20 of the internal node N1 from the negative value to the positive value with respect to the voltage V30 of the counter electrode 30, and are executed by extracting electrons from the internal node N1 to the internal node N2 with the tunnel current flowing through the tunnel insulating film 49 of the capacitor element 23.

For this reason, in the first writing operation, for example, a selected row voltage Vg1 (for example, 10 V) is applied to the gate lines GL of the selected rows, an unselected row voltage Vg0 (for example, 0 V) is applied to all the gate lines GL of the unselected rows, a pixel data voltage Vd1 (for example, 1 to 4 V) of a positive voltage corresponding to the pixel data to be written to each pixel circuit 2 is applied to all the source lines SL, and a negative voltage −Vcw1 (for example, −10 V) is applied to the counter electrode 30, so that a high voltage −Vw1 which is negative with respect to the second electrode (internal node N2) is applied to the first electrode (internal node N1) of the capacitor element 23. In this case, the negative voltage −Vcw1 corresponds to the first write voltage.

In the above voltage application state, in all the pixel circuits 2 of the selected rows, the transistor T1 (switch circuit 22) is in the ON state, and the pixel data voltage Vd1 applied to the source line SL is applied to the second electrode (internal node N2) of the capacitor element 23. In all the pixel circuits 2 of the unselected rows, the transistor T1 (switch circuit 22) is in the OFF state, and the second electrode (internal node N2) of the capacitor element 23 is in the floating state.

The voltage V30 applied to the counter electrode 30 changes from the data holding counter voltage Vch (0 V) to −Vcw1, and therefore, the voltage V20 applied to the first electrode (internal node N1) of the capacitor element 23 is given by equation 10 below. Cw denotes an electrical capacitance between the first and second electrodes of the capacitor element 23. Clc denotes an electrical capacitance between the pixel electrode 20 and the counter electrode 30 of the unit liquid crystal display element LC. Q2′ denotes the amount of electrical charge held in the capacitor element 23 of the amount of electrical charge Q2 held in the internal node N1 before the first writing operation. When the second writing operation is executed before the first writing operation, the amount of electrical charge Q2 is the amount of electrical charge corresponding to the pixel data written in the previous second writing operation or the amount of electrical charge after the first initialization operation. In the present embodiment, Clc>>Cw holds, and Clc is expected to be at a level about 1000 times larger than Cw, and the second term at the right hand side of equation 10, Clc/(Cw+Clc), can be approximated as one, and Q2′ can be approximated as Q2. Equation 10 is approximately expressed as equation 11 in view of Vch=0 V and Clc>>Cw.

V20=Clc×Q2′−(Vcw1+Vch)×Clc/(Cw+Clc) <Equation 10>

V20=Clc×Q2−Vcw1 <Equation 11>

The first terms at the right hand sides of equation 10 and equation 11, Clc×Q2′ and Clc×Q2, are the voltage V20 of the internal node N1 before the first writing operation. Therefore, in the pixel circuits 2 of the selected rows, the voltage −Vw1 applied between the first and second electrodes of the capacitor element 23 (between the internal nodes N1 and N2) is given as equation 12 below, which is derived from equation 11 described above.

−Vw1=−Vcw1−Vd1+Clc×Q2 <Equation 12>

For example, a description will be made supposing that Q2=0 and Vd1=1[V] hold. When the absolute value of the negative voltage (Vcw1+Vd1) applied between the first and second electrodes of the capacitor element 23 is a voltage high enough to generate the FN tunnel current, the FN tunnel current flows from the internal node N2 to the internal node N1, and the electrons (negative electrical charge) are extracted from the internal node N1 into the internal node N2. As a result, the amount of positive electrical charge held in the internal node N1 increases, and the voltage at the internal node N1 increases. In this case, when Q2>0 holds, the absolute value of the negative voltage (Vcw1+Vd1−Clc×Q2) applied between the first and second electrodes of the capacitor element 23 is a voltage lower than the case where Q2=0 holds, and this decreases the amount of the FN tunnel current. On the contrary, when Q2<0 holds, the absolute value of the negative voltage (Vcw1+Vd1−Clc×Q2) applied between the first and second electrodes of the capacitor element 23 is a voltage higher than the case where Q2=0 holds, and this increases the amount of the FN tunnel current. Therefore, an increase in the amount of electrical charge held in the internal node N1 is smaller as the amount of electrical charge Q2 before the first writing operation is larger, and the increase in the amount of electrical charge held in the internal node N1 is larger as the amount of electrical charge Q2 before the first writing operation is smaller, and therefore, the voltage V20′ of the internal node N1 after the FN tunnel current flows is substantially constant regardless of the amount of electrical charge Q2 before the first writing operation. On the other hand, when the pixel data voltage Vd1 is larger than 1 V, the absolute value of the voltage −Vw1 applied between the first and second electrodes of the capacitor element 23 (between the internal nodes N1 and N2) becomes larger, and accordingly, the amount of the FN tunnel current increases, and therefore, as compared with the case where Vd1 is 1 V, the amount of positive electrical charge held in the internal node N1 increases, and this further increases the voltage of the internal node N1. Therefore, by adjusting the pixel data voltage Vd1, the voltage of the internal node N1 after the first writing operation can be adjusted. When the voltage applied to the counter electrode 30 is changed from the negative voltage −Vcw1 back to the data holding counter voltage Vch (0 V), the FN tunnel current is no longer generated, and the first writing operation is terminated. When Clc>>Cw is considered to hold, a voltage V20″ of the internal node N1 after the first writing operation is given by equation 13 below.

V20″=V20′+Vcw <Equation 13>

The voltage V20′ at the right hand side of equation 13 is a voltage having a substantially constant value depending on the pixel data voltage Vd1 and the first write voltage −Vcw1, and therefore, the voltage V20″ in the internal node N1 after the first writing operation is adjusted to satisfy V20>V30 (=Vch) and Vt1≦Vpix≦Vt2′, by adjusting the pixel data voltage Vd1 and the first write voltage −Vcw1.

On the other hand, in the pixel circuits 2 of the unselected rows, the internal node N2 is in the floating state, and therefore, the voltage change of the internal node N1 becomes the voltage change of the internal node N2 due to the capacitive coupling through the capacitor element 23, and even when the voltage V30 applied to the counter electrode 30 changes from the data holding counter voltage Vch (0 V) to −Vcw1, the voltage applied between the first and second electrodes of the capacitor element 23 (between the internal nodes N1 and N2) does not change, and therefore, unlike the selected rows, the voltage V20 of the internal node N1 does not change, and the writing of the pixel data (first writing operation) does not occur.

### <<Second Writing Operation>>

Subsequently, the second writing operation will be described. The second writing operation is an operation in which the polarity of the voltage applied to each unit and the direction of the FN tunnel current are the same as those of the first initialization operation and are opposite to those of the first writing operation.

The pixel circuits 2 in the selected rows for the second writing operation are the pixel circuits 2 in the pixel data holding operation state after the second initialization operation or the first writing operation. If it is after the second initialization operation, then V20>V30 and Vpix>Vt2 hold, and if it is after the first writing operation, then V20>V30 and Vt1′≦Vpix≦Vt2′ hold. Therefore, the second writing operation is an operation for reversing the polarity of the pixel voltage Vpix of the internal node N1 from V20>V30 to V20<V30, and changing the absolute value thereof in accordance with the pixel data voltages provided to the source lines SL respectively connected to the selected pixel circuits 2. The reversing of the polarity of the pixel voltage Vpix and the change of the absolute value are operations for decreasing the voltage V20 of the internal node N1 from the positive value to the negative value with respect to the voltage V30 of the counter electrode 30, and are executed by injecting electrons from the internal node N2 to the internal node N1 with the tunnel current flowing through the tunnel insulating film 49 of the capacitor element 23.

For this reason, in the second writing operation, for example, a selected row voltage Vg1 (for example, 5 V) is applied to the gate lines GL of the selected rows, an unselected row voltage Vg0 (for example, −5 V) is applied to all the gate lines GL of the unselected rows, a pixel data voltage −Vd2 (for example, −1 to −4 V) of a negative voltage corresponding to the pixel data to be written to each pixel circuit 2 is applied to all the source lines SL, and a positive voltage +Vcw2 (for example, +10 V) is applied to the counter electrode 30, so that a high voltage +Vw2 which is positive with respect to the second electrode (internal node N2) is applied to the first electrode (internal node N1) of the capacitor element 23. In this case, the positive voltage +Vcw2 corresponds to the second write voltage.

In the above voltage application state, in all the pixel circuits 2 of the selected rows, the transistor T1 (switch circuit 22) is in the ON state, and the pixel data voltage Vd1 applied to the source line SL is applied to the second electrode of the capacitor element 23 (internal node N2). In all the pixel circuits 2 of the unselected rows, the transistor T1 (switch circuit 22) is in the OFF state, and the second electrode of the capacitor element 23 (internal node N2) is in the floating state.

The voltage V30 applied to the counter electrode 30 changes from the data holding counter voltage Vch (0 V) to +Vcw2, and therefore, the voltage V20 applied to the first electrode of the capacitor element 23 (internal node N1) is given by equation 14 below. Cw denotes an electrical capacitance between the first and second electrodes of the capacitor element 23. Clc denotes an electrical capacitance between the pixel electrode 20 and the counter electrode 30 of the unit liquid crystal display element LC. Q3′ denotes the amount of electrical charge held in the capacitor element 23 of the amount of electrical charge Q3 held in the internal node N1 before the second writing operation. When the first writing operation is executed before the second writing operation, the amount of electrical charge Q3 is the amount of electrical charge corresponding to the pixel data written in the previous first writing operation or the amount of electrical charge after the second initialization operation. In the present embodiment, Clc>>Cw holds, and Clc is expected to be at a level about 1000 times larger than Cw, and the second term at the right hand side of equation 14, Clc/(Cw+Clc), can be approximated as one, and Q3′ can be approximated as Q3. Equation 14 is approximately expressed as equation 15 in view of Vch=0 V and Clc>>Cw.

V20=Clc×Q3′+(Vcw2−Vch)×Clc/(Cw+Clc) <Equation 14>

V20=Clc×Q3+Vcw2 <Equation 15>

The first terms at the right hand sides of equation 14 and equation 15, Clc×Q3′ and Clc×Q3, are the voltage V20 of the internal node N1 before the second writing operation. Therefore, in the pixel circuits 2 of the selected rows, the voltage Vw2 applied between the first and second electrodes of the capacitor element 23 (between the internal nodes N1 and N2) is given as equation 16 below, which is derived from equation 15 described above.

Vw2=Vcw2+Vd2+Clc×Q3 <Equation 16>

For example, a description will be made supposing that Q3=0 and −Vd2=−1[V] hold. When the positive voltage (Vcw2+Vd2) applied between the first and second electrodes of the capacitor element 23 is a voltage high enough to generate the FN tunnel current, the FN tunnel current flows from the internal node N1 to the internal node N2, and the electrons (negative electrical charge) are injected from the internal node N2 into the internal node N1. As a result, the amount of positive electrical charge held in the internal node N1 decreases, and the voltage at the internal node N1 decreases. In this case, when Q3>0 holds, the positive voltage (Vcw2+Vd2+Clc×Q3) applied between the first and second electrodes of the capacitor element 23 is a voltage higher than the case where Q3=0 holds, and this increases the amount of the FN tunnel current. On the contrary, when Q3<0 holds, the positive voltage (Vcw2+Vd2+Clc×Q3) applied between the first and second electrodes of the capacitor element 23 is a voltage lower than the case where Q3=0 holds, and this decreases the amount of the FN tunnel current. Therefore, an increase in the amount of electrical charge held in the internal node N1 is larger as the amount of electrical charge Q3 before the second writing operation is larger, and the increase in the amount of electrical charge held in the internal node N1 is smaller as the amount of electrical charge Q3 before the second writing operation is smaller, and therefore, the voltage V20′ of the internal node N1 after the FN tunnel current flows is substantially constant regardless of the amount of electrical charge Q3 before the second writing operation. On the other hand, when the absolute value (Vd2) of the pixel data voltage −Vd2 is larger than 1 V, the absolute value of the voltage +Vw2 applied between the first and second electrodes of the capacitor element 23 (between the internal nodes N1 and N2) becomes larger, and accordingly, the amount of the FN tunnel current increases, and therefore, as compared with the case where −Vd2 is −1 V, the amount of positive electrical charge held in the internal node N1 decreases, and this further decreases the voltage of the internal node N1. Therefore, by adjusting the absolute value of the pixel data voltage −Vd2, the voltage of the internal node N1 after the second writing operation can be adjusted. When the voltage applied to the counter electrode 30 is changed from the positive voltage +Vcw2 back to the data holding counter voltage Vch (0 V), the FN tunnel current is no longer generated, and the second writing operation is terminated. When Clc>>Cw is considered to hold, a voltage V20″ of the internal node N1 after the second writing operation is given by equation 17 below.

V20″=V20′−Vcw2 <Equation 17>

The voltage V20′ at the right hand side of equation 17 is a voltage having a substantially constant value depending on the pixel data voltage −Vd2 and the second write voltage Vcw2, and therefore, the voltage V20″ in the internal node N1 after the second writing operation is adjusted to satisfy V20<V30 (=Vch) and Vt1′≦Vpix≦Vt2′, by adjusting the pixel data voltage −Vd2 and the second write voltage Vcw2.

On the other hand, in the pixel circuits 2 of the unselected rows, the internal node N2 is in the floating state, and therefore, the voltage change of the internal node N1 becomes the voltage change of the internal node N2 due to the capacitive coupling through the capacitor element 23, and even when the voltage V30 applied to the counter electrode 30 changes from the data holding counter voltage Vch (0 V) to +Vcw2, the voltage applied between the first and second electrodes of the capacitor element 23 (between the internal nodes N1 and N2) does not change, and therefore, unlike the selected rows, the voltage V20 of the internal node N1 does not change, and the writing of the pixel data (second writing operation) does not occur.

Hereinabove, the first and second initialization operations and the first and second writing operations of the display device 1a of the configuration A have been described in details. In the motion picture display in the normal display mode, when a pixel circuit 2 of a particular row is considered, the first writing operation and the second writing operation are alternately switched and executed in order on every frame period.

After the first or second writing operation is executed and before the subsequent second or first writing operation is executed, the pixel circuit 2 is in the pixel data holding operation state, and the internal node N1 is electrically separated by the unit liquid crystal display element LC and the capacitor element 23 from signal lines and the like which are driven by peripheral circuits such as the source line SL, the gate line GL, and the pixel electrode 30 and of which voltages are changed, and the pixel data written to the internal node N1 by the first and second writing operations are stably held in a non-volatile manner. This is regardless of the configuration of the display device 1 and regardless of whether the mode is the normal display mode or the constant display mode. Therefore, by using the pixel circuit 2, still picture display is possible even in the normal display mode, and in such case, the repetition cycle of the first writing operation and the second writing operation is a refresh period longer than one frame period.

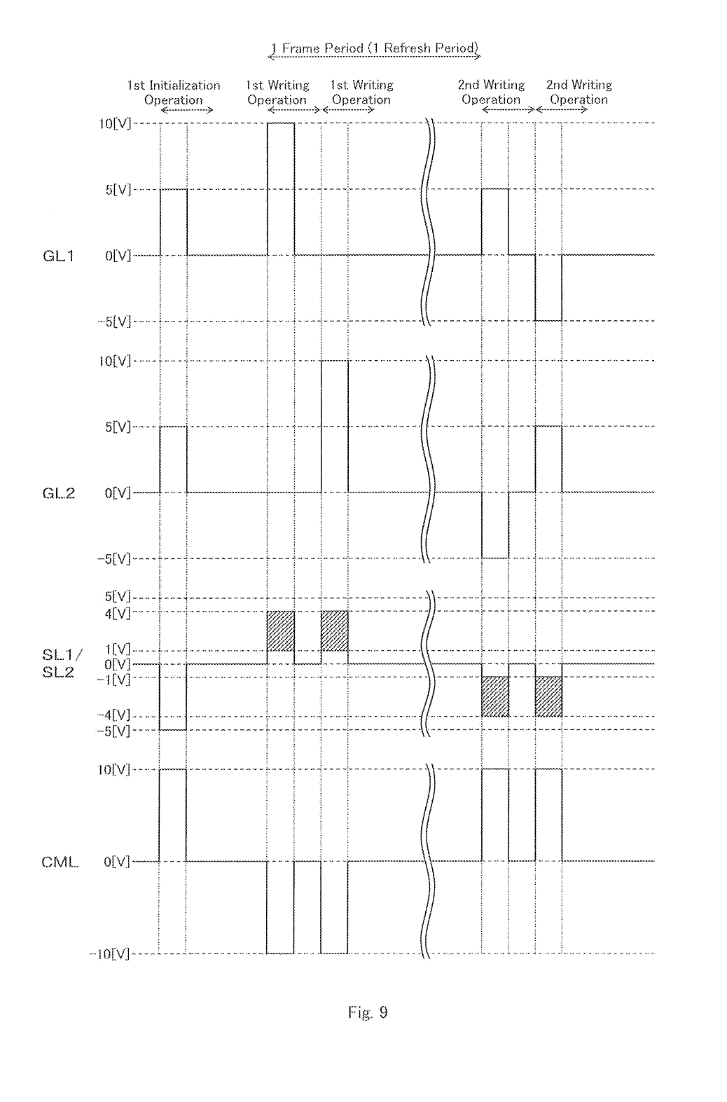

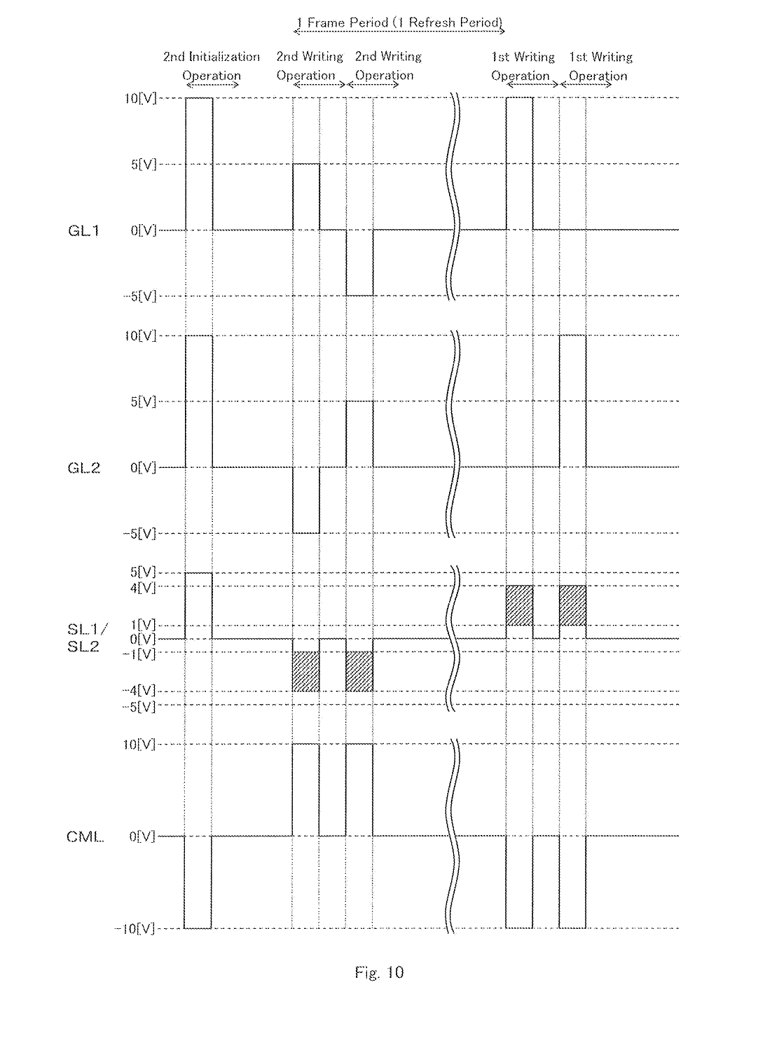

Subsequently, a further description will be given of the still picture display and the motion picture display in the constant display mode. In the constant display mode, the counter AC driving is executed in units of frames as described above, and therefore, the writing operation for one frame (the pixel circuits 2 of all the rows) for the first time is any one of the first writing operation and the second writing operation, and therefore, the initialization operation may also be one of the first initialization operation and the second initialization operation corresponding to the writing operation executed first. FIG. 9 schematically illustrates a voltage application waveform of each operation in the constant display mode for the display device 1a in a case where the writing operation executed first is the first writing operation and the initialization operation is the first initialization operation. FIG. 10 schematically illustrates a voltage application waveform of each operation in the constant display mode for the display device 1a in a case where the writing operation executed first is the second writing operation and the initialization operation is the second initialization operation. In the constant display mode, as illustrated in FIGS. 9 and 10, in the initialization operation, all the n gate lines GL are selected at a time, and in the writing operation, n gate lines GL are selected row by row in the order of arrangement, and (n−1) gate lines GL which are not selected are unselected. However, in one frame period, any one of the first and second writing operations is executed by selecting the n gate lines GL one by one in order, and therefore, the amplitude of the selected row voltage Vg1 applied to the selected gate line GL is constant throughout the one frame period. It should be noted that the first and second initialization operation and the first and second writing operation are the same as those of the normal display mode, and accordingly, the repeated description thereabout is omitted.

### <<Display Device of the Configuration B>>

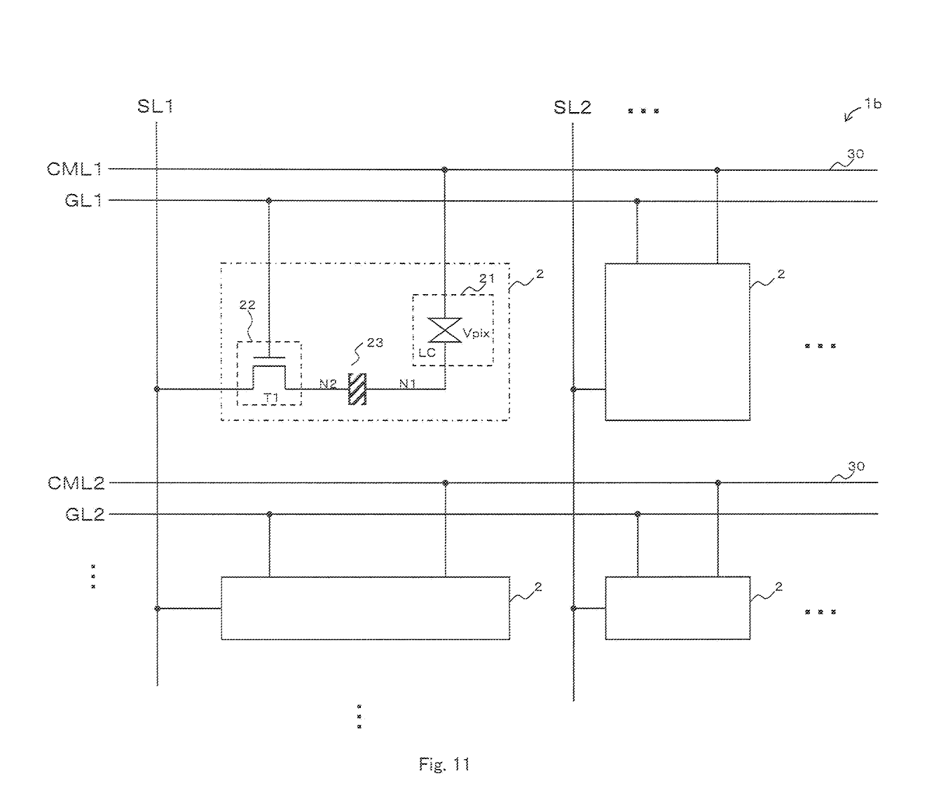

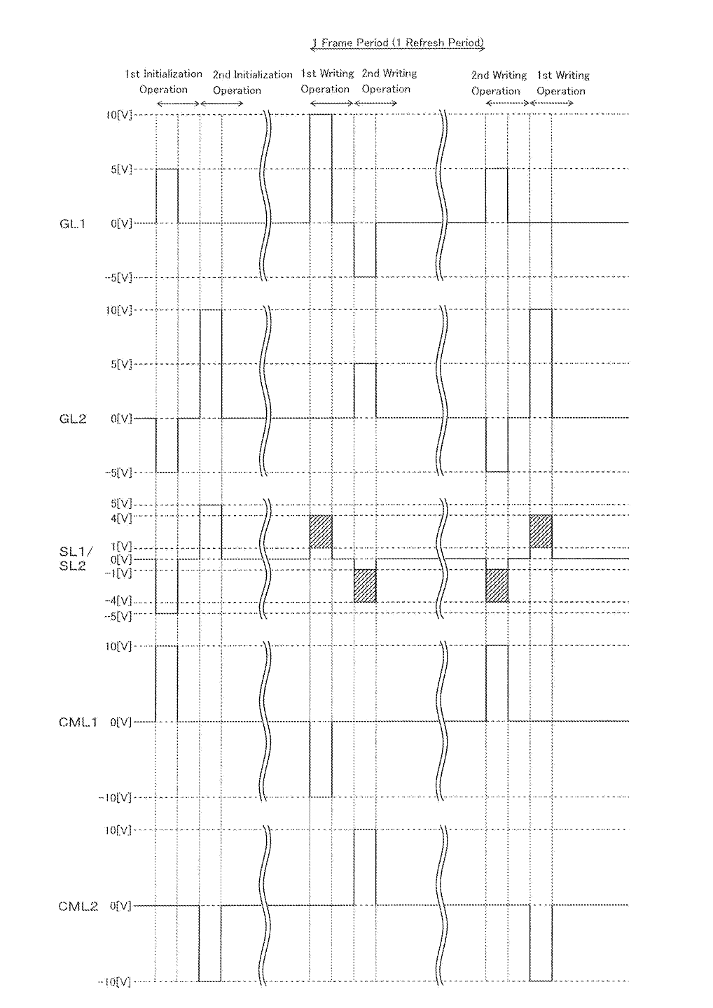

Hereinafter, each of the above operations of the display device 1b of the configuration B will be described. FIG. 11 schematically illustrates a portion of two rows by two columns of the pixel circuit array of the display device 1b of the configuration B. FIG. 12 schematically illustrates a voltage application waveform of each operation in the normal display mode to the display device 1b.

The pixel circuit array of the display device 1a of the configuration A and the pixel circuit array of the display device 1b of the configuration B are the same in that multiple same pixel circuits 2 are arranged in the row direction and the column direction, and in that pixel circuits 2 arranged in the same row are connected to the same gate line GL in common and pixel circuits 2 arranged in the same column are connected to the same source line SL in common. However, in the configuration A and the configuration B, the configurations of the counter electrodes 30 are different. In the display device 1b of the configuration B, the counter electrodes 30 are formed in such a manner that they are divided into rectangular shapes for each row of the pixel circuit array, and the pixel circuits 2 arranged in the same row are connected to the same pixel electrode 30 in common, and the pixel electrodes 30 in each row are driven by the counter electrode drive circuit 12 through the respectively corresponding counter electrode wirings CML (CML1, CML2, . . . , and CMLn).

In the first initialization operation, for example, a selected row voltage Vg1 (for example, 5 V) is applied to all the gate lines GL of the odd-numbered rows, an unselected row voltage Vg0 (for example, −5 V) is applied to all the gate lines GL of the even-numbered rows, a negative voltage −Vsi1 (for example, −5 V) is applied to all the source lines SL, a positive voltage Vci1 (for example, +10 V) is applied to all the counter electrodes 30 of the odd-numbered rows, and a data holding counter voltage Vch (0 V) is applied to all the counter electrodes 30 of the even-numbered rows, so that a high voltage +Vi1 which is positive with respect to the second electrode (internal node N2) is applied to the first electrode of the capacitor element 23 (internal node N1). In this case, the data holding counter voltage Vch corresponds to the unselected counter voltage. The first initialization operation of the odd-numbered rows (selected rows) is completely the same as that of the display device 1a of the configuration A, and accordingly, the repeated description thereabout is omitted. In the pixel circuits 2 of the even-numbered rows (unselected rows), the internal node N2 is in the floating state, and further, no voltage change is generated in the counter electrodes 30, and accordingly, the voltage applied between the first and second electrodes of the capacitor element 23 (between the internal nodes N1 and N2) does not change, and therefore, unlike the odd-numbered rows, the voltage V20 of the internal node N1 does not change, and the first initialization operation does not occur.

In the second initialization operation, for example, a selected row voltage Vg1 (for example, 10 V) is applied to all the gate lines GL of the even-numbered rows, an unselected row voltage Vg0 (for example, 0 V) is applied to all the gate lines GL of the odd-numbered rows, a positive voltage Vsi2 (for example, +5 V) is applied to all the source lines SL, a negative voltage −Vci2 (for example, −10 V) is applied to all the counter electrodes 30 of the odd-numbered rows, and a data holding counter voltage Vch (0 V) is applied to all the counter electrodes 30 of the even-numbered rows, so that a high voltage −Vi2 which is negative with respect to the second electrode (internal node N2) is applied to the first electrode of the capacitor element 23 (internal node N1). In this case, the data holding counter voltage Vch corresponds to the unselected counter voltage. The second initialization operation of the even-numbered rows (selected rows) is completely the same as that of the display device 1a of the configuration A, and accordingly, the repeated description thereabout is omitted. In the pixel circuits 2 of the odd-numbered rows (unselected rows), the internal node N2 is in the floating state, and further, no voltage change is generated in the counter electrodes 30, and accordingly, the voltage applied between the first and second electrodes of the capacitor element 23 (between the internal nodes N1 and N2) does not change, and therefore, unlike the even-numbered rows, the voltage V20 of the internal node N1 does not change, and the second initialization operation does not occur.

In the first writing operation, for example, a selected row voltage Vg1 (for example, 10 V) is applied to the gate lines GL of the selected rows, an unselected row voltage Vg0 (for example, 0 V) is applied to all the gate lines GL of the unselected rows, a pixel data voltage Vd1 (for example, 1 to 4 V) of a positive voltage corresponding to the pixel data to be written to each pixel circuit 2 is applied to all the source lines SL, a negative voltage −Vcw1 (for example, −10 V) is applied to the counter electrodes 30 of the selected rows, and a data holding counter voltage Vch (0 V) is applied to all the counter electrodes 30 of the unselected rows, so that a high voltage −Vw1 which is negative with respect to the second electrode (internal node N2) is applied to the first electrode of the capacitor element 23 (internal node N1). In this case, the data holding counter voltage Vch corresponds to the unselected counter voltage. The first writing operation of the selected rows is completely the same as that of the display device 1a of the configuration A, and accordingly, the repeated description thereabout is omitted. In the pixel circuits 2 of the unselected rows, the internal node N2 is in the floating state, and further, no voltage change is generated in the counter electrodes 30, and accordingly, the voltage applied between the first and second electrodes of the capacitor element 23 (between the internal nodes N1 and N2) does not change, and therefore, unlike the selected rows, the voltage V20 of the internal node N1 does not change, and the first writing operation does not occur.

In the second writing operation, for example, a selected row voltage Vg1 (for example, 5 V) is applied to the gate lines GL of the selected rows, an unselected row voltage Vg0 (for example, −5 V) is applied to all the gate lines GL of the unselected rows, a pixel data voltage −Vd2 (for example, −1 to −4 V) of a negative voltage corresponding to the pixel data to be written to each pixel circuit 2 is applied to all the source lines SL, a positive voltage +Vcw2 (for example, +10 V) is applied to all the counter electrodes 30 of the selected rows, and a data holding counter voltage Vch (0 V) is applied to all the counter electrodes 30 of the unselected rows, so that a high voltage +Vw2 which is positive with respect to the second electrode (internal node N2) is applied to the first electrode of the capacitor element 23 (internal node N1). In this case, the data holding counter voltage Vch corresponds to the unselected counter voltage. The second writing operation of the selected rows is completely the same as that of the display device 1a of the configuration A, and accordingly, the repeated description thereabout is omitted. In the pixel circuits 2 of the unselected rows, the internal node N2 is in the floating state, and further, no voltage change is generated in the counter electrodes 30, and accordingly, the voltage applied between the first and second electrodes of the capacitor element 23 (between the internal nodes N1 and N2) does not change, and therefore, unlike the selected rows, the voltage V20 of the internal node N1 does not change, and the second writing operation does not occur.

Hereinabove, the first and second initialization operations and the first and second writing operations of the display device 1b of the configuration B have been described. The difference from each of the operations of the display device 1a of the configuration A is that the voltage applied to the counter electrodes 30 of the pixel circuits 2 of the unselected rows is the data holding counter voltage Vch (0 V), and is separated from the voltage applied to the counter electrodes 30 of the pixel circuits 2 of the selected rows. Therefore, there is difference only in the voltage applied to the counter electrodes 30 of the pixel circuits 2 of the unselected rows, and accordingly, the display device 1b of the configuration B is the same as the display device 1a of the configuration A in that still picture display is enabled in the normal display mode, and still picture display and motion picture display are enabled in the constant display mode.

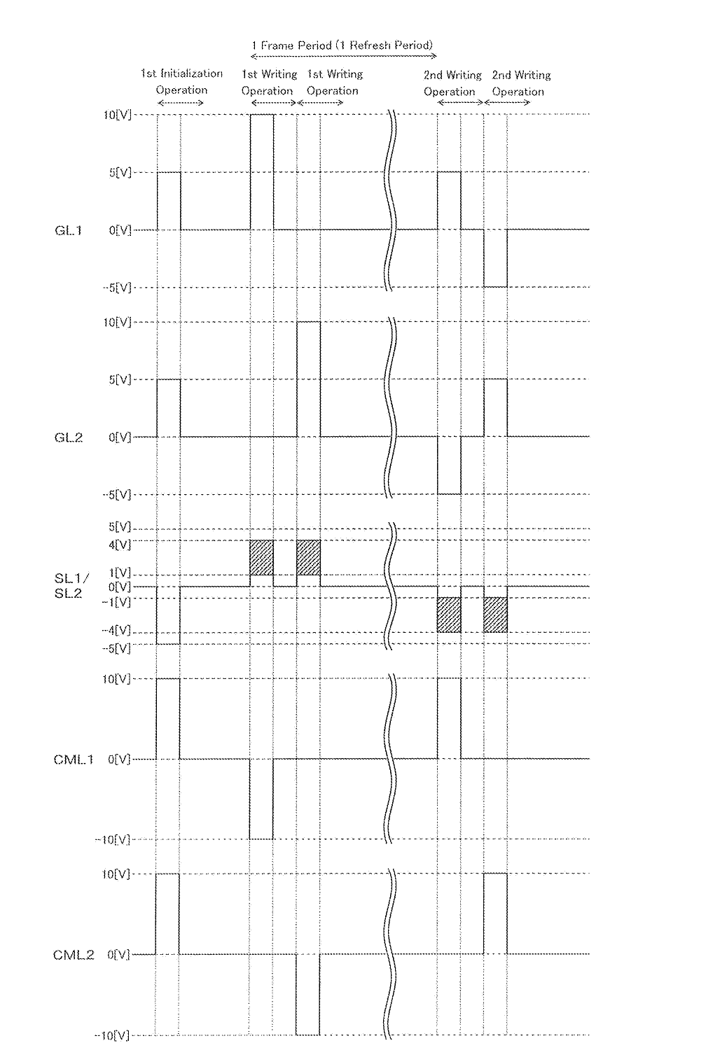

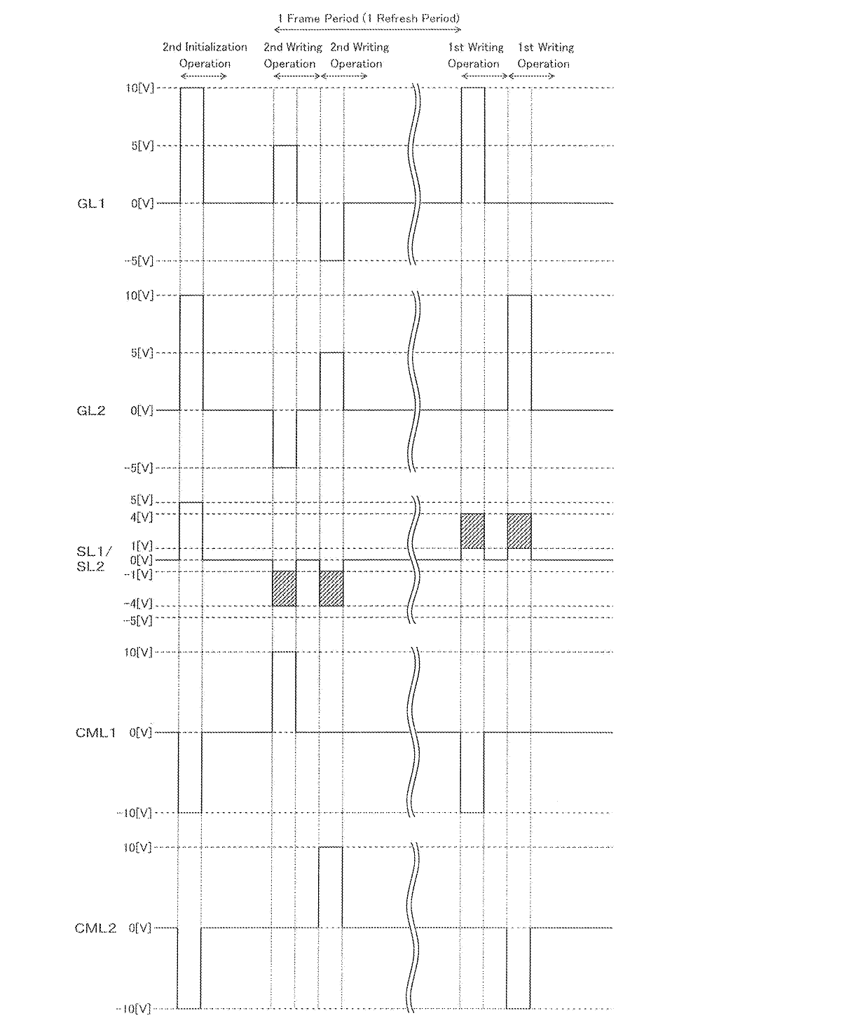

FIG. 13 schematically illustrates a voltage application waveform of each operation in the constant display mode for the display device 1b in a case where the writing operation executed first is the first writing operation and the initialization operation is the first initialization operation. FIG. 14 schematically illustrates a voltage application waveform of each operation in the constant display mode for the display device 1b in a case where the writing operation executed first is the second writing operation and the initialization operation is the second initialization operation. In the constant display mode, as illustrated in FIGS. 13 and 14, in the initialization operation, all the n gate lines GL and the counter electrodes 30 of all the rows are selected at a time, and in the writing operation, n gate lines GL and n counter electrodes 30 are selected row by row in the order of arrangement, and counter electrodes 30 and (n−1) gate lines GL which are not selected are unselected. The display device 1b of the configuration B is characterized in having select/unselect operation of n counter electrodes 30, and the other features of the display device 1b of the configuration B are the same as those of the display device 1a of the configuration A.

As is evident from the above description, in any of the display device 1a of the configuration A and the display device 1b of the configuration B, the first initialization operation and the second writing operation are basically the same operation except that they are different only in the absolute value of the voltage applied to the source line SL. This is also applicable to the second initialization operation and the first writing operation. More specifically, when a certain pixel circuit 2 is considered, the first and second writing operations are repeated in order on every frame period or every refresh period, but the each of the first and second writing operations also serves as the initialization operation for the subsequent second or first writing operation. Therefore, instead of the first and second initialization operations executed before the writing operation executed first, it may be possible to execute the second and first writing operations using dummy pixel data.

Further, in the above description, the entire pixel circuit array for one frame is used for any one of the motion picture display or the still picture display, but in any of the display device 1a of the configuration A and the display device 1b of the configuration B, the first and second writing operations may be repeatedly executed on every frame period with some rows of the pixel circuit array being for the motion picture display, and the first and second writing operations may be repeatedly executed on every refresh period longer than one frame period with some of the remaining rows being for the still picture display.

### Other Embodiments

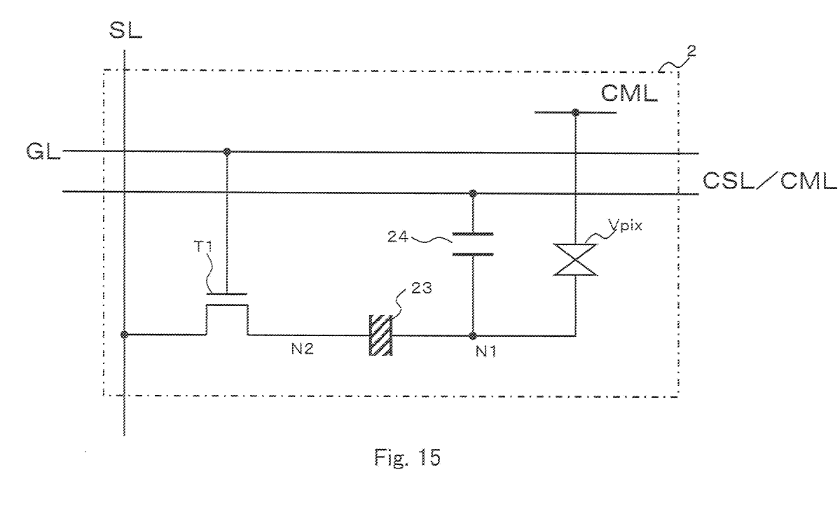

Other embodiments will be described below.
(1) In the above embodiment, as illustrated in FIG. 4, the pixel circuit 2 has an extremely simple configuration including the display element unit 21 including the unit liquid crystal display element LC, the switch circuit 22, and the capacitor element 23. In this case, as described above, the ratio of the electrical capacitance Clc of the unit liquid crystal display element LC to the electrical capacitance Cw of the capacitor element 23 (Clc/Cw) is equal to or more than about 1000, and the electrical capacitance Clc of the unit liquid crystal display element LC and the electrical capacitance Cw of the capacitor element 23 preferably satisfy Clc>>Cw. Therefore, when the actual ratio of the capacitance (Clc/Cw) does not satisfy the above condition, the pixel circuit 2 may be configured as follows. As illustrated in FIG. 15, an auxiliary capacitor element 24 may be provided, one end of which is connected to the internal node N1 and the other end is connected to the counter electrode 30 or a control line CSL driven at the same voltage as the counter electrode 30. However, the auxiliary capacitor element 24 is made using an insulating material and a film thickness that do not cause the FN tunnel phenomenon under the voltage application condition described above, unlike the capacitor element 23. In the present other embodiment, the auxiliary capacitor element 24 and the unit liquid crystal display element LC are connected in parallel, and the combined capacitance thereof is the electrical capacitance Clc of the unit liquid crystal display element LC in the above description.

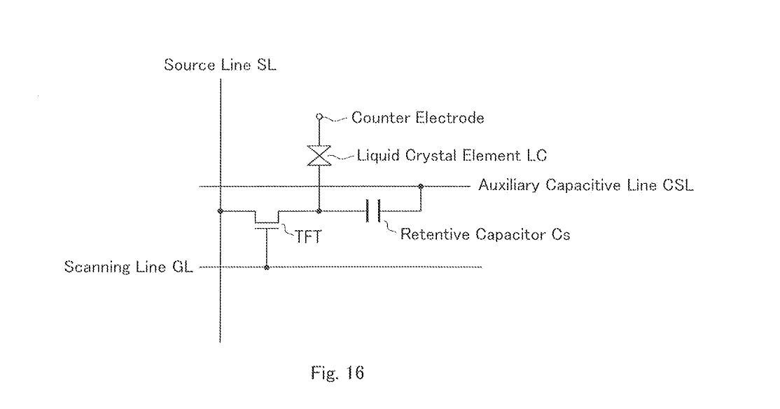

Further, even if the electrical capacitance Clc of the unit liquid crystal display element LC is extremely small, and, for example, the ratio of the capacitance (Clc/Cw) is expected to be equal to or less than 1 to about 10, the pixel circuit 2 illustrated in FIG. 15 may be configured as follows. Using the auxiliary capacitor element 24 of which electrical capacitance is large, the other end is connected to the control line CSL provided independently from the counter electrode 30, and like the drive method of the counter electrode 30 in the second embodiment, the control line CSL is driven, and the counter electrode 30 may be fixed to a certain voltage (for example, data holding counter voltage Vch (0 V)) through each of operations. In this case, the electrical capacitance Caux of the auxiliary capacitor element 24 is set so as to satisfy Caux>>(Clc+Cw). Even if Caux>>(Clc+Cw) is insufficient, the electrical charge induced in the internal node N1 with the capacitive coupling through the auxiliary capacitor element 24 is distributed into the unit liquid crystal display element LC and the capacitor element 23, and therefore, the voltage value driving the control line CSL needs to be set in view of the electrical charge distribution. As described above, when, instead of the counter electrode 30, the control line CSL is driven, it is not necessary to divide the counter electrodes 30, and accordingly, the configuration of the display device 1 may be configured such that the counter electrodes 30 of all the pixel circuits 2 are integrally formed as illustrated in FIG. 1. On the other hand, the configuration of the control line CSL is considered to be such that, instead of dividing it like the counter electrodes 30 of the configuration A, the control line CSL may be controlled for all of the pixel circuits 2 in common (configuration C), or it may be divided like the counter electrodes 30 of the configuration B and, for example, controlled in units of rows (configuration D), or it may be divided into two and the even-numbered rows and the odd-numbered rows are separately controlled (configuration E). In the configurations C and E, the display control circuit 11 may drive the control line CSL, and in the configuration D, the gate driver 14 may drive n control lines CSL in units of rows.
(2) In the description about the above embodiment, in the display device 1b of the configuration B, the counter electrodes 30 are formed in such a manner that they are divided into rectangular shapes for each row of the pixel circuit array, and there are as many counter electrodes 30 as the number of the rows. Preferably, the counter electrodes 30 may be configured as being divided into two counter electrodes, i.e., those for the odd-numbered rows and those for the even-numbered rows. According to the configuration, in both of the first and second initialization operations in the normal display mode, either the pixel electrodes 30 of the odd-numbered rows or the pixel electrodes of the even-numbered rows are selected and the second initialization voltage is applied thereto, and the data holding counter voltage Vch (0 V) is applied to the other pixel electrodes 30, so that this can simplify the control of the counter electrodes 30 in the initialization operation of the display device 1b of the configuration B. According to the configuration, in the first and second writing operations in the normal display mode, when the first and second writing operations are switched and repeatedly executed on every horizontal period, the selected row voltage having a voltage value of the same polarity can be repeatedly applied throughout one frame period, to the counter electrodes 30 for the odd-numbered rows and the even-numbered rows, and therefore, as compared with the display device 1a of the configuration A, the control of the counter electrodes 30 is simplified, and as compared with the case where the counter electrodes 30 are divided into pieces as many as the number of rows in the display device 1b of the configuration B, the control of the counter electrodes 30 can be simplified.
(3) In the second embodiment, the first and second initialization operations and the first and second writing operations of each of the normal display mode and the constant display mode have been described. For the pixel circuit array on which the first and second writing operations are executed in the normal display mode, the mode may be switched to the constant display mode, and the first and second writing operation may be executed, or for the pixel circuit array on which the first and second writing operations are executed in the constant display mode, the mode may be switched to the normal display mode, and the first and second writing operation may be executed. However, immediately after the display mode is switched, the first or second writing operation is executed continuously in either the even-numbered rows or the odd-numbered rows, and therefore, it is preferable to execute, as preprocessing, the second or first writing operation using dummy pixel data or the first or second initialization operation on the rows where the same writing operation is continuously executed.
(4) In the above embodiment, all the pixel circuits 2 made on an active matrix substrate 10 are considered to be pixel circuits 2 having the circuit configuration illustrated in FIG. 4. In contrast, on the active matrix substrate 10, some of the pixel circuit array may be made using the pixel circuits 2 having the circuit configuration illustrated in FIG. 4, and some of the remaining pixel circuit array may be made using the pixel circuit having the conventional circuit configuration illustrated in FIG. 16. For example, when two types of pixel units, i.e., a transmissive pixel unit for transmissive liquid crystal display and a reflective pixel unit for reflective liquid crystal display, are provided on the active matrix substrate 10, pixel circuits in the reflective pixel unit may be the pixel circuits 2 having the circuit configuration illustrated in FIG. 4, and pixel circuits in the transmissive display unit may be the pixel circuits having the conventional circuit configuration illustrated in FIG. 16. In this case, motion pictures in the normal display mode are displayed by the transmissive pixel unit, and images in the constant display mode are displayed by the reflective pixel unit.
(5) Although the transistor T1 in the pixel circuit 2 is assumed to be an N channel type polysilicon TFT in the above embodiments, it may be possible to employ a configuration using a P channel type TFT or employ a configuration using an amorphous silicon TFT. A display device employing the configuration using the P channel type TFT can also operate the pixel circuit 2 similar to the above second embodiment by adjusting the selected row voltage Vg1 and the unselected row voltage Vg0 in each of the operations, and can provide the same effect.
(6) In the description about the second embodiment, specific numerical values are clearly mentioned as the voltages applied to the gate line GL, the source line SL, and the counter electrode 30 in each operation, but these voltage value may be changed as necessary in accordance with characteristics (transmittance characteristics, electrical capacitance, FN tunnel current characteristics, threshold voltage, and the like) of the unit liquid crystal display element LC, the capacitor element 23, and the transistor T1.
(7) In the above embodiments, the FN tunnel current is used in the description as the tunnel current flowing through the capacitor element 23, but depending on the material constituting the tunnel insulating film constituting the capacitor element 23, it may not be the FN tunnel current and may be a PF current caused by application of high electrical field and a leak current flowing due to other conduction mechanisms.

### EXPLANATION OF REFERENCES

1: DISPLAY DEVICE

2: PIXEL CIRCUIT

10: ACTIVE MATRIX SUBSTRATE

11: DISPLAY CONTROL CIRCUIT

12: COUNTER ELECTRODE DRIVE CIRCUIT

13: SOURCE DRIVER

14: GATE DRIVER

20: PIXEL ELECTRODE

21: DISPLAY ELEMENT UNIT

22: SWITCH CIRCUIT

23: CAPACITOR ELEMENT

24: AUXILIARY CAPACITOR ELEMENT

30: COUNTER ELECTRODE

31: COUNTER SUBSTRATE

32: SEALING MEMBER

33: LIQUID CRYSTAL LAYER

40: GLASS SUBSTRATE

41: BUFFER LAYER

42: POLYCRYSTALLINE SILICON REGION

43: GATE INSULATING FILM

44: GATE ELECTRODE

45: SOURCE ELECTRODE

46: FIRST ELECTRODE OF CAPACITOR ELEMENT

47: INTERLAYER INSULATING FILM

48: SECOND ELECTRODE OF CAPACITOR ELEMENT

49: TUNNEL INSULATING FILM

CML (CML1, CML2, . . . and CMLn): COUNTER ELECTRODE WIRING

CSL: CONTROL LINE

Ct: TIMING SIGNAL

DA: DIGITAL IMAGE SIGNAL

Dv: DATA SIGNAL

GL (GL1, GL2, . . . and GLn): GATE LINE

Gtc: SCAN SIDE TIMING CONTROL SIGNAL

LC: UNIT LIQUID CRYSTAL DISPLAY ELEMENT

N1: INTERNAL NODE

N2: INTERNAL NODE

Sec: COUNTER VOLTAGE CONTROL SIGNAL

SL (SL1, SL2, . . . and SLm): SOURCE LINE

Stc: DATA SIDE TIMING CONTROL SIGNAL

T1: THIN FILM TRANSISTOR

V20: PIXEL VOLTAGE

V30: COUNTER VOLTAGE

1. A pixel circuit comprising:
a display element unit including a unit liquid crystal display element having a liquid crystal layer sandwiched between a pixel electrode and a counter electrode;
a capacitor element having a tunnel insulating film sandwiched between first and second electrodes, wherein a tunnel current flows between the first and second electrodes when a predetermined high voltage is applied between the first and second electrodes; and
a switch circuit having a first terminal, a second terminal, and a control terminal, the first terminal being connected to the second electrode of the capacitor element, the second terminal being connected to a data signal line, the control terminal being connected to a scanning signal line and controlling electrical connection between the first and second terminals, wherein
a voltage corresponding to pixel data with a voltage of the counter electrode being a reference is held in an internal node connecting the pixel electrode and the first electrode of the capacitor element.

2. The pixel circuit according to claim 1, wherein
the switch circuit includes a thin film transistor element having a first terminal, a second terminal, and a control terminal for controlling electrical connection between the first and second terminals.

3. The pixel circuit according to claim 1, comprising
an auxiliary capacitor element having one end connected to the internal node and the other end connected to the counter electrode or a predetermined control line.

4. A display device in which
a plurality of pixel circuits are arranged in a row direction and a column direction to form a pixel circuit array, each of the pixel circuits being the pixel circuit according to claim 1,
data signal lines are provided for respective columns one by one,
scanning signal lines are provided for respective rows one by one,
the second terminals of the switch circuits in the pixel circuits arranged in the same column are connected to one of the data signal lines in common, and
the control terminals of the switch circuits in the pixel circuits arranged in the same row are connected to one of the scanning signal lines in common,
the display device comprising:
a data signal line drive circuit individually driving the data signal lines;
a scanning signal line drive circuit individually driving the scanning signal lines, and
a counter electrode drive circuit driving the counter electrode.

5. The display device according to claim 4, wherein
a plurality of counter electrodes are provided for the pixel circuit array, and one of the counter electrodes is shared by the plurality of pixel circuits in one or more rows, and
the counter electrode drive circuit individually drives the plurality of counter electrodes.

6. The display device according to claim 4, wherein,
upon a first writing operation of writing pixel data including two tones or more individually in the pixel circuits arranged in one selected row by supplying a voltage of a first polarity which is positive or negative to the internal node with the counter electrode being a reference,
the scanning signal line drive circuit applies a predetermined selected row voltage to the scanning signal line of the selected row to set the switch circuits of the pixel circuits arranged in the selected row to a conducting state, and applies a predetermined unselected row voltage to the scanning signal line in a row other than the selected row to set the switch circuits of the pixel circuits arranged in the row other than the selected row to a non-conducting state, and
the data signal line drive circuit individually applies, to each of the data signal lines, a pixel data voltage corresponding to pixel data to be written in the pixel circuit in each column of the selected row, and the counter electrode drive circuit applies, to the counter electrode, a first write voltage having a polarity opposite to the first polarity with each of the data signal lines being a reference, and in the pixel circuits arranged in the selected row, the tunnel current is passed between the first and second electrodes of the capacitor element, and a voltage of the internal node with the counter electrode being a reference is raised when the first polarity is positive and is reduced when the first polarity is negative.

7. The display device according to claim 6, wherein,
upon a second writing operation of writing pixel data including two tones or more individually in the pixel circuits arranged in one selected row by supplying a voltage of a polarity opposite to the first polarity to the internal node with the counter electrode being a reference,
the scanning signal line drive circuit applies a predetermined selected row voltage to the scanning signal line of the selected row to set the switch circuits of the pixel circuits arranged in the selected row to a conducting state, and applies a predetermined unselected row voltage to the scanning signal line in a row other than the selected row to set the switch circuits of the pixel circuits arranged in the row other than the selected row to a non-conducting state, and
the data signal line drive circuit individually applies, to each of the data signal lines, a pixel data voltage having a polarity opposite to that of the pixel data voltage applied in the first writing operation and corresponding to pixel data to be written in the pixel circuit in each column of the selected row, and the counter electrode drive circuit applies, to the counter electrode, a second write voltage having the first polarity with each of the data signal lines being a reference, and in the pixel circuits arranged in the selected row, the tunnel current is passed between the first and second electrodes of the capacitor element, and a voltage of the internal node with the counter electrode being a reference is reduced when the first polarity is positive and is raised when the first polarity is negative.

8. The display device according to claim 7, wherein
the first writing operation and the second writing operation are alternately executed on the same pixel circuit.

9. The display device according to claim 6, wherein,
upon an initialization operation of collectively returning the pixel circuits arranged in one or more selected rows to an initial state before pixel data including two tones or more is written,
the scanning signal line drive circuit applies a predetermined selected row voltage to the scanning signal line of the selected row to set the switch circuits of the pixel circuits arranged in the selected row to a conducting state, and applies a predetermined unselected row voltage to the scanning signal line in a row other than the selected row to set the switch circuits of the pixel circuits arranged in the row other than the selected row to a non-conducting state, and
the data signal line drive circuit applies a first initialization voltage to each of the data signal lines, the counter electrode drive circuit applies a second initialization voltage to the counter electrode, and in the pixel circuits arranged in the selected row, the tunnel current is passed between the first and second electrodes of the capacitor element, and a voltage of the internal node with the counter electrode being a reference is raised or reduced to initialize the pixel circuits.

10. The display device according to claim 5, wherein,
upon a first writing operation of writing pixel data including two tones or more individually in the pixel circuits arranged in one selected row by supplying a voltage of a first polarity which is positive or negative to the internal node with the counter electrode being a reference,
the scanning signal line drive circuit applies a predetermined selected row voltage to the scanning signal line of the selected row to set the switch circuits of the pixel circuits arranged in the selected row to a conducting state, and applies a predetermined unselected row voltage to the scanning signal line in a row other than the selected row to set the switch circuits of the pixel circuits arranged in the row other than the selected row to a non-conducting state, and
the data signal line drive circuit individually applies, to each of the data signal lines, a pixel data voltage corresponding to pixel data to be written in the pixel circuit in each column of the selected row, and the counter electrode drive circuit applies, to the counter electrode of the selected row, a first write voltage having a polarity opposite to the first polarity with each of the data signal lines being a reference, and applies, to the counter electrode of the row other than the selected row, a predetermined unselected counter voltage, and in the pixel circuits arranged in the selected row, the tunnel current is passed between the first and second electrodes of the capacitor element, and a voltage of the internal node with the counter electrode being a reference is raised when the first polarity is positive and is reduced when the first polarity is negative.

11. The display device according to claim 10, wherein,
upon a second writing operation of writing pixel data including two tones or more individually in the pixel circuits arranged in one selected row by supplying a voltage of a polarity opposite to the first polarity to the internal node with the counter electrode being a reference,
the scanning signal line drive circuit applies a predetermined selected row voltage to the scanning signal line of the selected row to set the switch circuits of the pixel circuits arranged in the selected row to a conducting state, and applies a predetermined unselected row voltage to the scanning signal line in the row other than the selected row to set the switch circuits of the pixel circuits arranged in the row other than the selected row to a non-conducting state, and
the data signal line drive circuit individually applies, to each of the data signal lines, a pixel data voltage having a polarity opposite to that of the pixel data voltage applied in the first writing operation and corresponding to pixel data to be written in the pixel circuit in each column of the selected row, and the counter electrode drive circuit applies, to the counter electrode of the selected row, a second write voltage having the first polarity with each of the data signal lines being a reference, and applies, to the counter electrode of the row other than the selected row, a predetermined unselected counter voltage, and in the pixel circuits arranged in the selected row, the tunnel current is passed between the first and second electrodes of the capacitor element, and a voltage of the internal node with the counter electrode being a reference is reduced when the first polarity is positive and is raised when the first polarity is negative.

12. The display device according to claim 11, wherein
the first writing operation and the second writing operation are alternately executed on the same pixel circuit.

13. The display device according to claim 10, wherein,
upon an initialization operation of collectively returning the pixel circuits arranged in one or more selected rows to an initial state before pixel data including two tones or more is written,
the scanning signal line drive circuit applies a predetermined selected row voltage to the scanning signal line of the selected row to set the switch circuits of the pixel circuits arranged in the selected row to a conducting state, and applies a predetermined unselected row voltage to the scanning signal line in the row other than the selected row to set the switch circuits of the pixel circuits arranged in the row other than the selected row to a non-conducting state, and
the data signal line drive circuit applies a first initialization voltage to each of the data signal lines, the counter electrode drive circuit applies a second initialization voltage to the counter electrode of the selected row, and applies a predetermined unselected counter voltage to the counter electrode of the row other than the selected row, and in the pixel circuits arranged in the selected row, the tunnel current is passed between the first and second electrodes of the capacitor element, and a voltage of the internal node with the counter electrode being a reference is raised or reduced to initialize the pixel circuits.
